(19) United States
(12) Patent Application Publication
(10) Pub. No.: US 2023/0036834 A1
(43) Pub. Date: Feb. 2, 2023

(54) INFORMATION PROCESSING SYSTEM, APPARATUS, AND STORAGE MEDIUM HAVING COMBINATIONAL AND NON-COMBINATIONAL APPLICATIONS

(71) Applicant: CANON KABUSHIKI KAISHA, Tokyo (JP)

(72) Inventors: Atsushi Ikeda, Ibaraki (JP); Takeshi Kogure, Ibaraki (JP); Hiroaki Koike, Tokyo (JP); Sora Kumagai, Chiba (JP)

(21) Appl. No.: 17/815,868

(22) Filed: Jul. 28, 2022

(30) Foreign Application Priority Data
Jul. 30, 2021 (JP) 2021-125160

(51) Int. Cl. G06F 16/954; G06F 16/955; G06F 16/957

(52) U.S. Cl. CPC G06F 16/954; G06F 16/955; G06F 16/957

(57) ABSTRACT

An information processing apparatus includes one or more controllers configured to function as first, second, and third units. The first unit is configured to register, as a combinational application, combinational information about a description file, in which an operation procedure is defined, and a reproduction application, which reproduces the description file. The second unit is configured to register a non-combinational application which does not use the description file. The third unit is configured to output list information including identification information about the combinational application and identification information about the non-combinational application. In the list information, identification information about the description file is used as the identification information about the combinational application.

### BACKGROUND

### Technical Field

One disclosed aspect of the embodiments generally relates to an authoring system. In particular, an aspect relates to custom applications in an authoring system.

### Description of the Related Art

There is known a mechanism which installs an application on an information processing apparatus, such as a multifunction peripheral (MFP), to expand the functions thereof. Japanese Patent Application Laid-Open No. 2016-24701 discusses a technique to manage an application installed on an information processing apparatus with use of, for example, identification data (ID).

Customers who handle information processing apparatuses have various needs. Therefore, it is desirable to provide functions matched to the customers' needs in the form of applications. Moreover, it is favorable that, to swiftly respond to the customers' requests, persons concerned, such as service engineers or sales representative, are able to customize applications and provide the customized applications to the customers.

### SUMMARY

One disclosed aspect of the embodiments is generally directed to providing an information processing apparatus capable of appropriately discriminating a custom application that is based on a description file and application data.

According to an aspect of the embodiments, an information processing apparatus includes one or more controllers configured to function as first, second, and third units. The first unit is configured to register, as a combinational application, combinational information about a description file, in which an operation procedure is defined, and a reproduction application, which reproduces the description file. The second unit is configured to register a non-combinational application which does not use the description file. The third unit is configured to output list information including identification information about the combinational application and identification information about the non-combinational application. In the list information, identification information about the description file is used as the identification information about the combinational application.

Further features of the disclosure will become apparent from the following description of exemplary embodiments with reference to the attached drawings.

### BRIEF DESCRIPTION OF THE DRAWINGS

FIG. 1 is a diagram used to explain an authoring system.

FIG. 2A is a diagram illustrating a software configuration of the authoring system. FIG. 2B is a diagram illustrating a hardware configuration of a server apparatus which is used for the authoring system.

FIG. 3A is a diagram illustrating a hardware configuration of a multifunction peripheral (MFP). FIG. 3B is a diagram illustrating a software configuration of the MFP.

FIG. 4 is a diagram illustrating a hierarchical structure of software in the MFP.

FIG. 5A is a diagram illustrating a hardware configuration of a client terminal. FIG. 5B is a diagram illustrating a software configuration of a description editor, which the client terminal executes.

FIG. 6 is a diagram illustrating a hierarchical structure of software related to the description editor.

FIG. 7A is a diagram illustrating a screen of the description editor. FIG. 7B is a diagram illustrating an execution screen of a custom application in the MFP.

FIG. 8 is a diagram illustrating a sequence between software modules of the description editor.

FIG. 9 is a diagram illustrating a usage flow in the authoring system.

FIG. 10 is a diagram illustrating a data structure of the custom application.

FIG. 11, which is composed of FIGS. 11A and 11B, is a diagram illustrating a description.

FIG. 12A is a diagram used to explain installation of a custom application. FIG. 12B is a diagram used to explain installation of a normal application.

FIGS. 13A, 13B, 13C, and 13D are flowcharts illustrating the installation flows of applications.

FIG. 14A is a diagram illustrating application meta-information. FIG. 14B is a diagram illustrating description meta-information.

FIG. 15A is a diagram illustrating an application management screen. FIG. 15B is a diagram illustrating an application management screen in a comparative example.

FIG. 16 is a diagram illustrating an application detailed screen.

FIG. 17 is a diagram illustrating the flow of application management.

FIG. 18 is a flowchart illustrating acquisition processing for application information.

FIG. 19 is a diagram used to explain installation of a custom application.

### DESCRIPTION OF THE EMBODIMENTS

Various exemplary embodiments, features, and aspects of the disclosure will be described in detail below with reference to the drawings. Furthermore, the scope of the disclosure is not limited to configurations described in the exemplary embodiments. Such configurations can be subjected to alterations or modifications, such as a part of the configurations or a part of processing being replaced by an equivalent or being omitted, within a range in which similar advantageous effects are obtainable. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above

A mechanism which provides a customized application (custom application) by a combination of description information serving as descriptive data, which is easily editable, and a general-purpose reproduction application. Since types of such custom applications increase in proportion to the number of customers' requests, it is desirable to build out an environment capable of appropriately managing the custom applications.

Particularly, since the custom application having the above-mentioned configuration uses a general-purpose reproduction application for a different purpose, it is difficult to appropriately discriminate the custom application only by information acquirable from the general-purpose reproduction application. It is desired that an information processing apparatus be capable of appropriately discriminating such a custom application.

### <Authoring System>

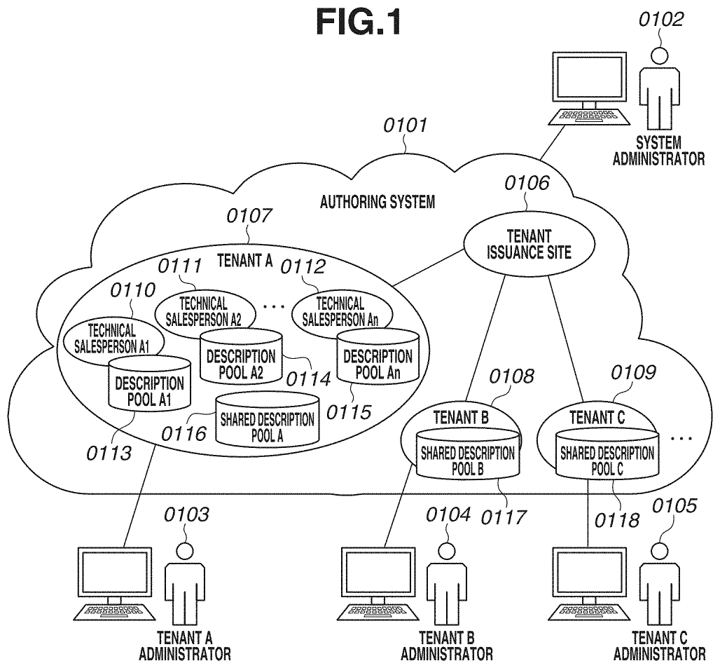

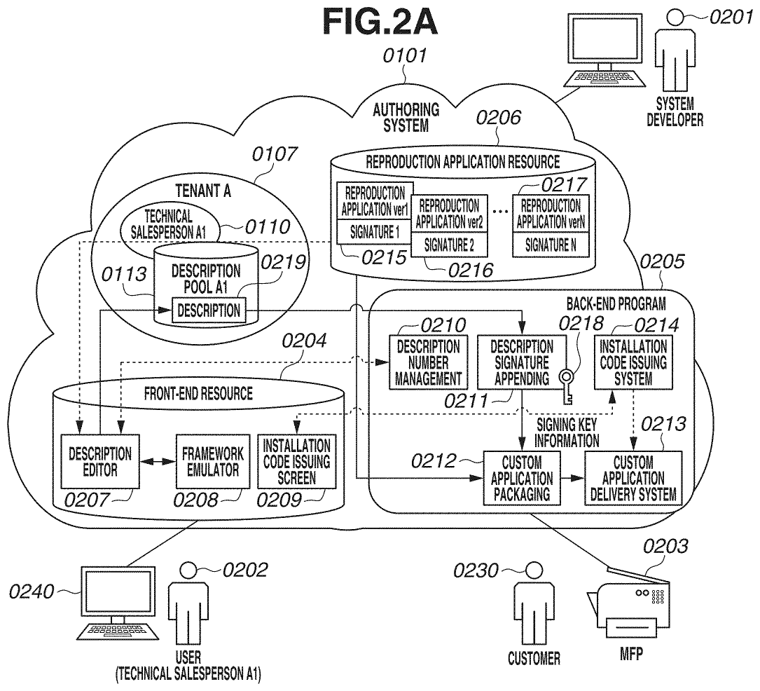

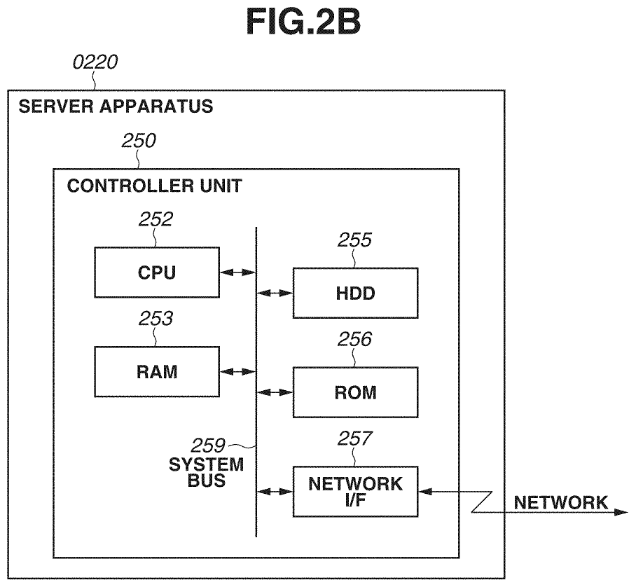

FIG. 1 is a diagram used to explain an authoring system. The authoring system 0101 is an information processing system which provides an editing environment for custom applications which are to be executed by a multifunction peripheral (MFP) 0203 (FIG. 2A). In the present exemplary embodiment, using the authoring system 0101 enables a person concerned, such as a service engineer or a sales representative, to customize an application. This enables swiftly providing a custom application which meets a customer's request. Moreover, this enables appropriately managing custom applications the types of which progressively increase for customers' requests.

The authoring system 0101 is a system which is built out on a general-purpose cloud service, and is able to be accessed by various apparatuses via a network. All of the administrators and users who use the authoring system 0101 are subjected to login management according to a mechanism for user authentication. Thus, at the start of using the authoring system 0101, an administrator or user performs a user authentication procedure using, for example, a user identification (ID) and a password. In the present exemplary embodiment, a function which a general-purpose cloud service provides is assumed to be used as the mechanism for user authentication, and the detailed description thereof is omitted. Furthermore, the authoring system 0101 can be configured to include its own user authentication function.

The authoring system 0101 includes a tenant issuance site 0106, and is able to create a plurality of tenants depending on the intended use. FIG. 1 illustrates a state in which at least a tenant A (0107), a tenant B (0108), and a tenant C (0109) have been issued. For example, a system administrator 0102 is able to create tenants with respect to group sales companies for respective countries by accessing the tenant issuance site 0106 from a client terminal 0240 (FIG. 2A) via a web browser. The authoring system 0101 can issue tenants with respect to not group sales companies but system integrators.

In a case where tenants have been issued, one or more administrators are allocated to one tenant and thus manage the tenant. FIG. 1 illustrates an example in which at least a tenant A administrator 0103, who manages the tenant A (0107), a tenant B administrator 0104, who manages the tenant B (0108), and a tenant C administrator 0105, who manages the tenant C (0109) exist. A tenant administrator for a given tenant is able to set or delete another tenant administrator.

A tenant administrator is able to access a managed tenant from the client terminal 0240 via a web browser and create a plurality of user accounts of users who use the tenant. FIG. 1 illustrates an example in which the tenant A administrator 0103 has created accounts of a technical salesperson A1 (0110), a technical salesperson A2 (0111), . . . , and a technical salesperson An (0112). A description pool in which a description is stored is allocated to each account. Here, the description is a file (description file) in which a behavior (an operation procedure, a screen configuration, a screen transition, and a job execution) of the custom application is described and is able to be created with use of the authoring system 0101. Furthermore, a configuration of the custom application and the details of a description are described below.

FIG. 1 illustrates a manner in which respective application pools are allocated to accounts of the technical salesperson A1 (0110), the technical salesperson A2 (0111), . . . , and the technical salesperson An (0112). A description pool A1 (0113), a description pool A2 (0114), . . . , and a description pool An (0115) (n being a natural number) are allocated to the respective accounts. Furthermore, although omitted from illustration in FIG. 1, the tenant B administrator and the tenant C administrator are also able to similarly create accounts of the users in the respective tenants as appropriate. Moreover, the tenant administrator arranges a shared description pool in a tenant, thus being able to allow one description to be shared by a plurality of accounts. FIG. 1 illustrates an example in which, since a shared description pool A (0116) is arranged in the tenant A (0107), a description is shared in the tenant A (0107). As a similar configuration of sharing a description in a tenant, a shared description pool B (0117) is arranged in the tenant B (0108) and a shared description pool C (0118) is arranged in the tenant C (0109).

Furthermore, in the description of the present exemplary embodiment, a shared description pool is assumed to be set in such a manner that all of the accounts in a tenant are able to perform read and write. Furthermore, setting of a shared description pool can be changed in such a manner that read or write is limited depending on accounts. Moreover, the authoring system 0101 can include a shared description pool which the accounts of all of the tenants are able to access. In this case, limitations can also be set to such a shared description pool depending on accounts.

### (Usage Flow in System>

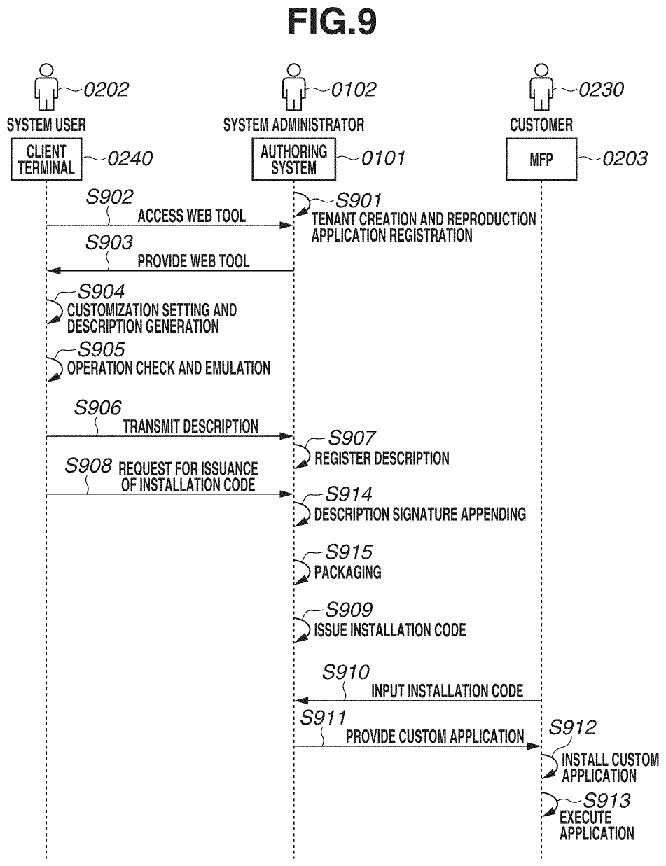

A principal usage flow in the authoring system is described with reference to FIG. 9. FIG. 9 is a diagram illustrating a usage flow in the authoring system.

In step S901, the system administrator 0102 performs tenant creation processing and reproduction application registration processing with respect to the authoring system 0101. In the authoring system 0101, there are registered information about normal applications in addition to a reproduction application for custom applications. These applications are managed in such a way as to be distinguishable from each of the other applications based on uniquely discriminable information. In step S902, a system user 0202 accesses a web tool based on tenant information with use of the client terminal 0240. In step S903, the client terminal 0240 acquires the web tool from the authoring system 0101 via a network.

In step S904 to step S907, in response to instructions from the system user 0202, the client terminal 0240 performs generation processing and registration processing for a description using the web tool. The description registered with the authoring system 0101 is managed in such a way as to be distinguishable from the other descriptions based on uniquely discriminable information. The details of the generation processing and registration processing for a description are described below.

In step S908, the client terminal 0240 transmits, to the authoring system 0101, an issuance request for an installation code with respect to a custom application which uses the registered description.

In step S914, the authoring system 0101, having received the installation code issuance request, appends signature information to a description 0219 by using signing key information 0218 in description signature appending 0211 described below. Furthermore, the signing key information 0218 is information different from key information which is used for signature of a preproduction application described below. The key information which is used for signature of a preproduction application is managed in a development environment of a system developer 0201.

In step S915, the authoring system 0101 performs packaging processing on the description with a signature appended thereto and the signature-appended reproduction application in custom application packaging 0212.

In step S909, the authoring system 0101 issues an installation code in an installation code issuing system 0214, and registers the packaged custom application with a custom application delivery system 0213. The installation code which has been issued is communicated from the system user 0202 to a customer 0230 via a transmission method such as telephone or e-mail.

In step S910, in response to the customer 0230 inputting the installation code to the MFP 0203, the MFP 0203 transmits the installation code to the authoring system 0101.

In step S911, the authoring system 0101 provides, to the MFP 0203, a custom application corresponding to the received installation code in the custom application delivery system 0213.

In step S912, the MFP 0203, having received the custom application, installs the custom application thereon. When installation is completed in a normal way, in step S913, the MFP 0203 executes the application, thus entering into a state in which the customer 0230 is able to use a function which the application provides.

### <Software Configuration of Authoring System>

Next, a software configuration of the authoring system 0101 is described. FIG. 2A is a diagram illustrating a software configuration of the authoring system 0101.

In FIG. 2A, the authoring system 0101, the tenant A (0107), the technical salesperson A1 (0110), which is a user account, and the description pool A1 (0113) are the same as those illustrated in FIG. 1.

The authoring system 0101 includes software modules including a front-end resource 0204, a back-end program 0205, and a reproduction application resource 0206.

The front-end resource 0204 contains resources including, for example, a description editor 0207, a framework emulator 0208, and an installation code issuing screen 0209. Each resource is a program described in terms of, for example, JavaScript, and operates on a World Wide Web browser (web browser) which the user uses when accessing the authoring system 0101.

The description editor 0207 is a program (editing program) which operates on a web browser when the user of each tenant performs, for example, creation and editing of a description. A description created by the description editor 0207 is able to be stored in a description pool associated with the user account. FIG. 2A illustrates an example in which the technical salesperson A1 (0202) serving as the user has logged in to the authoring system 0101 and is accessing the front-end resource 0204. Moreover, FIG. 2A illustrates a manner in which a description 0219 which the technical salesperson A1 (0202) serving as the user has created with use of the description editor 0207 contained in the front-end resource 0204 has been stored in the description pool A1 (0113). As mentioned above, the description pool A1 (0113) is associated with the technical salesperson A1 (0110), which is a user account created by the tenant A (0107).

The framework emulator 0208 is a program which is invoked in checking, within the description editor 0207, a behavior of a description which is being created (being edited) or has been created on the description editor 0207. The framework emulator 0208 is configured to operate on a web browser. The framework emulator 0208 emulates an operation of an application framework in a device and outputs, as screen information, a behavior of a custom application including the created description, thus making such a behavior visible.

The installation code issuing screen 0209 is a program which displays, on a web browser which the user uses, an installation code which is used to install a custom application on a device.

The back-end program 0205 contains, for example, description number management 0210, description signature appending 0211, custom application packaging 0212, a custom application delivery system 0213, and an installation code issuing system 0214.

Each program contained in the back-end program 0205 is executed by a server apparatus 0220 on a cloud in which the authoring system 0101 is hosted, and operates in collaboration with each program contained in the front-end resource 0204.

The description number management 0210 is a program which issues a unique serial number used for discriminating each individual description. The description number management 0210 is invoked when the user starts creating a new description with use of the description editor 0207. Moreover, the description number management 0210 is also invoked when the user discards a description created in the past. If a description intended to be discarded is not being used as a custom application, the description number management 0210 takes charge of processing for, for example, returning a serial number allocated at the time of creation of such a description to a reusable state.

The description signature appending 0211 is a program which appends, to a description, a signature used to ensure that the description has not been tampered with. Appending of a signature is performed, for example, at the time of creation of an installation package for a custom application including the created description. The description signature appending 0211 includes signing key information 0218 which is used in performing such signing. FIG. 2A illustrates an example in which the description 0219 stored in the description pool A1 (0113) is cited by the description signature appending 0211.

The custom application packaging 0212 is a program which performs conversion of a custom application into an installation package. The installation package is a combination obtained by unifying a signed description generated by the description signature appending 0211 and a specific reproduction application described below. Conversion into an installation package enables installing a custom application on an optional device. Furthermore, the details of a structure of the installation package are described below.

The custom application delivery system 0213 is a system program which delivers, to a device, an installation package for one or more custom applications previously associated with an installation code issued by the installation code issuing screen 0209. Here, the installation package for one or more custom applications is assumed to be referred to as an “installation package archive for custom applications”. When receiving a delivery request accompanied by an installation code from the device, the custom application delivery system 0213 transmits, to the device, the installation package archive for a custom application associated with the installation code. FIG. 2A illustrates an example in which the MFP 0203 serving as the device is connected to the back-end program 0205 of the authoring system 0101, so that the installation package for custom applications is sequentially transmitted to the MFP 0203.

The installation code issuing system 0214 is a program which operates in collaboration with the installation code issuing screen 0209 and issues installation codes for one or more custom applications selected by the user. Moreover, the installation code issuing system 0214 retains therein a table indicating a relationship between the selected one or more custom applications (i.e., an installation package archive for custom applications) and the issued installation codes. The details thereof are described below.

Here, the installation package archive for custom applications can be configured to be generated on demand or can be configured to be generated in advance.

If configured to be generated on demand, the installation package archive for custom applications is generated by the custom application packaging 0212 after the custom application delivery system 0213 has received, from the device, a delivery request accompanied by an installation code. On the other hand, if configured to be generated in advance, the installation package archive for custom applications is generated by the custom application packaging 0212 when the installation code issuing system 0214 has issued an installation code. Then, the installation package archive for custom applications is retained in the installation code issuing system 0214 together with a table indicating a relationship with the issued installation code.

The reproduction application resource 0206 is an application which operates to reproduce the created description and contains a signed application, which is a package with a signature appended thereto in advance. The number of reproduction applications which are managed by the reproduction application resource 0206 is not limited to one. For example, a plurality of reproduction applications can be managed in such a manner that, for example, reproduction applications are managed separately for every version. FIG. 2A illustrates an example in which the reproduction application resource 0206 contains a reproduction application ver1 (0215), a reproduction application ver2 (0216), . . . , and a reproduction application verN (0217), to each of which a signature has been appended in advance. Corresponding signatures “signature 1”, “signature 2”, . . . , and “signature N” are appended to the respective reproduction applications. Each reproduction application is developed by the system developer 0201. Moreover, a signature for a reproduction application is appended beforehand in a development environment of the system developer 0201 in which key information used for the signature is rigidly managed. Then, the reproduction application with a signature appended thereto in advance is uploaded by the system developer 0201 to the reproduction application resource 0206 on a timely basis. Additionally, each reproduction application which is contained in the reproduction application resource 0206 includes customizable information. When causing the description editor 0207 to start creating a description, the user selects the version of a reproduction application. Then, the description editor 0207 acquires, from the selected version of reproduction application, customizable information specific to the reproduction application. This eliminates the necessity of the description editor 0207 statically retaining such information as menu items required for customization.

### <Server Apparatus>

A hardware configuration for implementing the software configuration of the authoring system 0101 described with reference to FIG. 2A is described. The authoring system 0101 is a system built out on a cloud, and is, therefore, configured in such a manner that a load is decentralized by a plurality of devices. In the present exemplary embodiment, for ease of explanation, a case where processing is performed by a single server apparatus 0220 is described. FIG. 2B is a diagram illustrating a hardware configuration of the server apparatus 0220 used for the authoring system 0101.

The server apparatus 0220 is an information processing apparatus which operates to implement an authoring system, and includes a controller unit 250. The controller unit 250 includes a central processing unit (CPU) 252, a random access memory (RAM) 253, a hard disk drive (HDD) 255, a read-only memory (ROM) 256, and a network interface (I/F) 257. The CPU 252, the RAM 253, the HDD 255, the ROM 256, and the network I/F 257 are interconnected via a system bus 259.

The CPU 252 is a unit which controls an operation of the server apparatus 0220, and operates based on a program stored in the RAM 253. The ROM 256 is a boost ROM, and has a system boot program stored therein. The network I/F 257 is connected to a local area network (LAN), and takes charge of inputting and outputting of various pieces of information via a network. The HDD 255 has, stored therein, for example, various programs including system software. A program stored in the HDD 255 is loaded onto the RAM 253, and the CPU 252 controls an operation of the server apparatus 0220 based on the loaded program.

For example, account information about administrators and users and information about various tenants typified by the tenant A (0107) illustrated in FIG. 2A, which have been described above, are all retained and managed on the HDD 255. For example, the front-end resource 0204, the back-end program 0205, and the reproduction application resource 0206 illustrated in FIG. 2A are also stored on the HDD 255. Additionally, although not illustrated, for example, a program for implementing a mechanism of user authentication for administrators and users described with reference to FIG. 1 is also retained on the HDD 255. The program for implementing a mechanism of user authentication is automatically loaded onto the RAM 253 in response to start-up of the server apparatus 0220 and is then executed by the CPU 252. For example, if the system developer 0201 or the user (technical salesperson A1) 0202 illustrated in FIG. 2A accesses the authoring system 0101 to try to log in thereto, such a request is communicated to a user authentication program via the network I/F 257. Then, a login screen is displayed by the user authentication program on a web browser of, for example, a personal computer (PC) which the system developer 0201 or the user (technical salesperson A1) 0202 is using. For example, the description editor 0207, which is contained in the front-end resource 0204, is also retained on the HDD 255. For example, the user (technical salesperson A1) 0202 logs in to the authoring system 0101 and accesses a Uniform Resource Locator (URL) of the description editor 0207, such a request is communicated to the server apparatus 0220 via the network I/F 257. Then, a program of the description editor 0207 is returned to a web browser of the PC which the user (technical salesperson A1) 0202 is using, and operates on the web browser. Similar processing is also performed with respect to the framework emulator 0208 and the installation code issuing screen 0209.

For example, the description number management 0210 which is contained in the back-end program 0205 is also retained on the HDD 255. As mentioned above, the back-end program 0205 is driven in collaboration with various programs of the front-end resource 0204. Various modules including the description number management 0210 contained in the back-end program 0205 are loaded from the HDD 255 onto the RAM 253 in response to a request for driving thereof and are then executed by the CPU 252.

### <MFP>

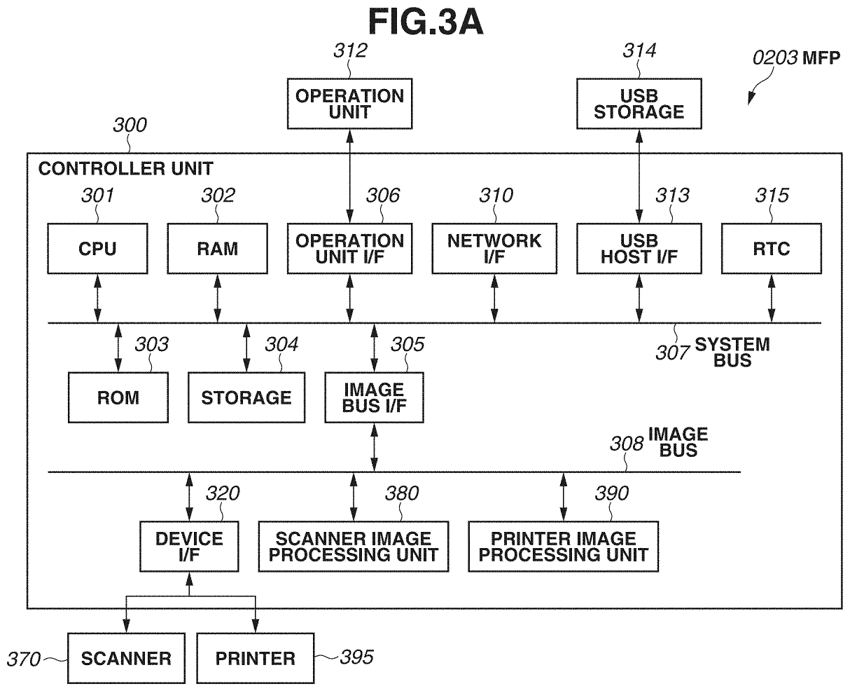

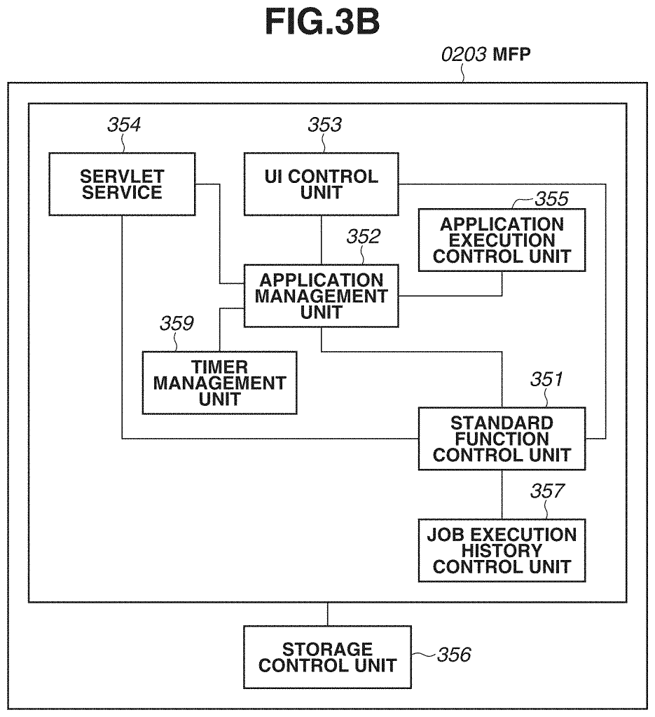

The MFP 0203 is an information processing apparatus which processes information, is an image processing apparatus which processes an image, and is an image forming apparatus which forms an image on a sheet. FIG. 3A is a diagram illustrating a hardware configuration of the MFP 0203. FIG. 3B is a diagram illustrating a software configuration of the MFP 0203.

The MFP 0203 includes a controller unit 300, a printer 395, a scanner 370, an operation unit 312, and a Universal Serial Bus (USB) storage 314. The controller unit 300 performs control to implement a copy function of printing and outputting image data read by the scanner 370 with use of the printer 395. The scanner 370 is an image reading unit which reads an image from an original. The printer 395 is an image forming unit which forms an image on a sheet (paper). The operation unit 312 is a reception unit which receives an instruction from the user and is a display unit which displays information to the user.

The controller unit 300 includes a CPU 301, and the CPU 301 starts up an operating system (OS) by a boot program stored in a ROM 303.

The CPU 301 executes a program stored in a storage 304 on the OS, thus performing various processing operations. A RAM 302 is used as a work area for the CPU 301. The RAM 302 not only provides a work area but also provides an image memory area for temporarily storing image data. The storage 304 stores programs and image data.

To the CPU 301, there are connected, via a system bus 307, the ROM 303, the RAM 302, an operation unit interface (operation unit I/F) 306, a network interface (network I/F) 310, a USB host I/F 313, and an image bus interface (image bus I/F) 305. The operation unit I/F 306 is an interface with the operation unit 312, which includes a touch panel, and outputs, to the operation unit 312, image data to be displayed on the operation unit 312. Moreover, the operation unit I/F 306 sends out, to the CPU 301, information input by the user via the operation unit 312. The network I/F 310 is an interface for connecting the MFP 0203 to a LAN. The USB host I/F 313 is an interface unit for communicating with the USB storage 314. The USB host I/F 313 is an output unit which causes data stored in the storage 304 to be stored in the USB storage 314. Moreover, the USB host I/F 313 inputs data stored in the USB storage 314 and then communicates the input data to the CPU 301. The USB storage 314 is an external storage device which stores data, and is detachably attachable to the USB host I/F 313. A plurality of USB devices including the USB storage 314 is connectable to the USB host I/F 313. A real-time clock (RTC) 315 controls current clock time. Clock time information which is controlled by the RTC 315 is used for, for example, recording of a job submission time. The image bus I/F 305 is a bus bridge which interconnects the system bus 307 and an image bus 308, which is used to transfer image data at high speed, to convert a data format. The image bus 308 is configured with, for example, a Peripheral Component Interconnect (PCI) bus or Institute of Electrical and Electronics Engineers (IEEE) 1394. On the image bus 308, there are provided a device I/F 320, a scanner image processing unit 380, and a printer image processing unit 390. The scanner 370 and the printer 395 are connected to the device I/F 320, and the device I/F 320 performs conversion between a synchronous system and an asynchronous system of image data. The scanner image processing unit 380 performs correction, modification, or editing on input image data. The printer image processing unit 390 performs, for example, correction or resolution conversion corresponding to the printer 395 with respect to print output image data.

Each module illustrated in FIG. 3B is implemented by the CPU 301 loading a program stored in the storage 304 onto the RAM 302 and executing the program. FIG. 3B is a diagram illustrating a software configuration of the MFP 0203.

The MFP 0203 includes, as its software configuration, a servlet service 354, a user interface (UI) control unit 353, an application management unit 352, a storage control unit 356, an application execution control unit 355, a standard function control unit 351, a timer management unit 359, and a job execution history control unit 357.

The servlet service 354 is a module which receives, when accessed in HyperText Transfer Protocol (HTTP) via the network I/F 310, such a request. Then, the servlet service 354 allocates processing to a module (any one of the application management unit 352 and the standard function control unit 351) depending on the accessed URL.

The UI control unit 353 is a module which displays a screen on the operation unit 312, receives an operation from the user, and communicates such operation information to an applicable module (any one of the application management unit 352 and the standard function control unit 351). The application management unit 352 is a module which performs management of, for example, installation and start-up of an extended application 440 which is previously installed.

The application execution control unit 355 is a module which performs execution control of an application which has been started up by the application management unit 352. Specifically, the application execution control unit 355 controls a virtual machine (VM) thread 415, a VM system service 420, a VM 430, and an extended application 440.

The storage control unit 356 is a module which performs recording management of a program of the extended application 440 and setting information.

The application execution control unit 355 accesses the storage control unit 356 and then reads out a program of the application. Moreover, each module accesses the storage control unit 356 and then performs reference and setting of setting values.

The standard function control unit 351 is a module which performs control of copying and facsimile (FAX), which are standard functions of the MFP 0203, and other control required for the MFP 0203 (for example, control of the USB host I/F 313). Moreover, the standard function control unit 351 manages, for example, the executed copying or facsimile as a job, and requests the job execution history control unit 357 to record a result of execution of the job. To retain the result of execution of the job as a history in a storage, the job execution history control unit 357 requests the storage control unit 356 to record the history.

The timer management unit 359 acquires current clock time information from the RTC 315, detects that a specific clock time has passed, and notifies the application management unit 352. The application management unit 352 receives a notification from the timer management unit 359 and then requests the application execution control unit 355 to execute timer processing for an application.

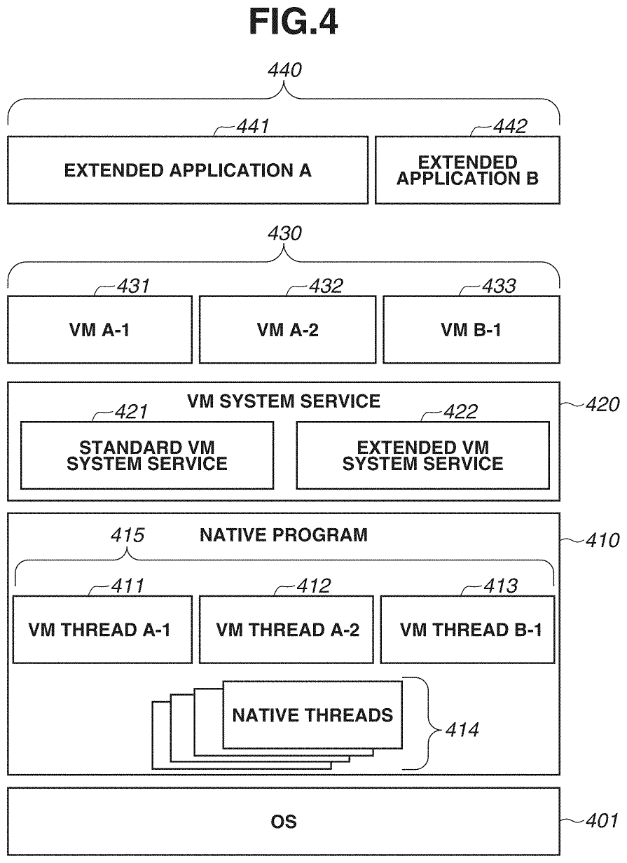

Here, a relationship between an OS, a VM, and an application is described in detail. FIG. 4 is a diagram illustrating a hierarchical structure of software in the MFP 0203.

On an operating system (OS) 401, a native program 410, which is provided to control image processing units such as a printer, facsimile apparatus, and a scanner, operates. Moreover, on the OS 401, a virtual machine (VM) 430, which is an execution environment for the extended application 440, operates. The VM 430 is a module which comprehends and executes a program for controlling the extended application 440. The extended application 440 always operates on the VM 430. A program which operates on the VM 430 operates according to an instruction exclusively used for the VM 430, which is different from an instruction operating on the CPU 301. This instruction exclusively used for the VM 430 is referred to “bytecode”. On the other hand, an instruction exclusively used for a CPU is referred to as “native code”. The VM sequentially interprets and processes this bytecode, so that, on the CPU 301, the native code and the bytecode for the VM operate. The VM includes a type which sequentially interprets and processes bytecode in a direct manner and a type which converts bytecode into native code and executes the native code. The VM 430 in the present exemplary embodiment is of the former type but can be of the latter type.

As, generally, if types of CPUs are different, instructions which operate on the respective CPUs are not compatible, if types of VMs are different, instructions which operate on the VMs are also not compatible. While, in the present exemplary embodiment, an extended application is assumed to be configured in Lua programming language, another language can be employed. In the case of Lua programming language, a script described in Lua programming language is converted into bytecode exclusively used for Lua programming language and the bytecode is executed on the VM 430 exclusively used for Lua programming language. Naturally, since bytecode in Lua programming language is different from instruction code which the CPU 301 is able to directly execute, bytecode in Lua programming language is not able to be directly executed by the CPU 301. The VM 430 for Lua programming language is configured with instruction code for the CPU 301 as a software module for sequentially interpreting and executing bytecode in Lua programming language. Naturally, the VM 430 can be configured as dedicated hardware which interprets and executes bytecode in Lua programming language.

The native program 410 contains therein native threads 414, which are used to control image processing units such as a printer, a facsimile apparatus, and a scanner, and VM threads 415, each of which is used to cause the VM 430 to operate. The number of VM threads 415 corresponds to the number of VMs 430. Here, there are generated three threads, i.e., a VM thread A-1 (411), a VM thread A-2 (412), and a VM thread B-1 (413).

A VM system service 420 is a utility library which is used in common by each extended application 440. Invoking the function of the VM system service 420 from the extended application 440 enables accelerating a speed of developments of the extended application 440. Moreover, the VM system service 420 is able to access each module of the MFP 0203. The VM system service 420 includes a standard VM system service 421, which causes the minimum operation to be performed as a VM, and an extended VM system service 422, which provides the functions of access and the OS to each module of the MFP 0203. The standard VM system service 421 also includes a function of loading the extended application 440. With regard to the VM system service 420, in response to the VM 430 executing an application programming interface (API) designated by bytecode included in the extended application 440, a VM system service 420 associated with the API is invoked. To the extended VM system service 422, there are provided a drawing API, which is used to perform optional drawing on a screen of the operation unit 312, and a job control API, which is used to make a request for execution of an optional job, such as copying or scanning in the MFP 0203.

The VM 430 executes the extended application 440. The VM 430 is generated for every thread of the extended application 440. In FIG. 4, there are generated a VM A-1 (431) and a VM A-2 (432), which are used to cause two threads to operate in an extended application A (441). Moreover, in FIG. 4, there is generated a VM B-1 (433), which is used to cause one thread to operate in an extended application B (442).

Moreover, an icon for each extended application 440 is displayed in a menu screen displayed on the operation unit 312 of the MFP 0203. When the operation unit I/F 306 detects, via the operation unit 312, that the user has selected this icon, the operation unit I/F 306 transmits that effect to the CPU 301. The CPU 301, having received that effect, starts up the extended application 440 selected by the user.

In the subsequent description, such a mechanism as to cause the extended application 440 to operate on the MFP 0203 (i.e., the VM system service 420 and the VM 430) is referred to as an “application framework”.

### <Client Terminal>

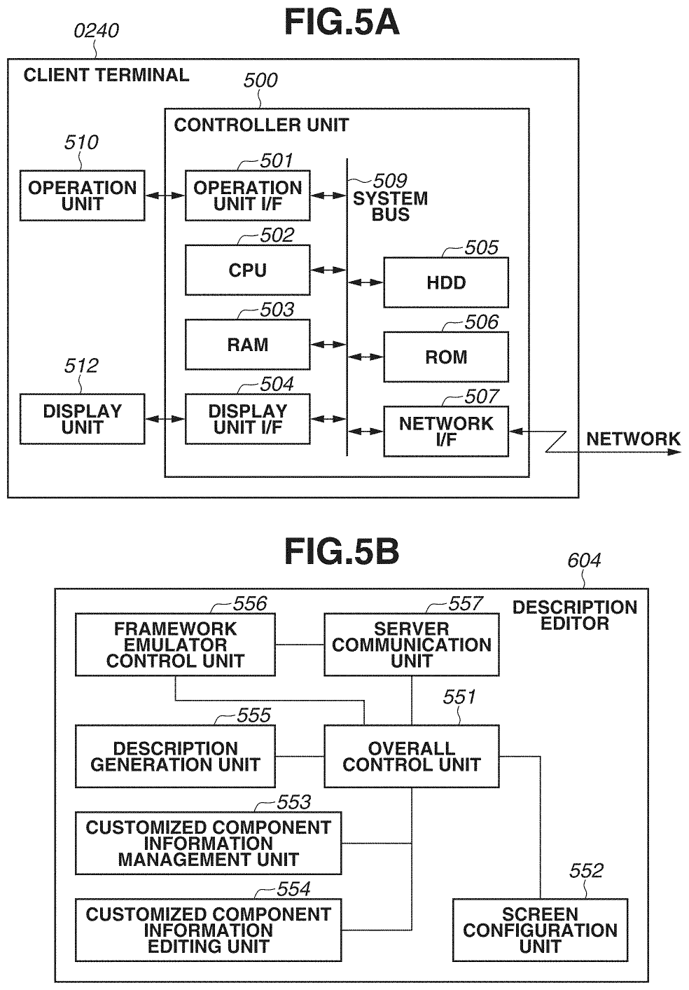

The client terminal 0240, which the user 0202 uses, is described as a representative of a general client terminal employed in the present system. Furthermore, a configuration which is described here can be applied to a client terminal which, for example, the system administrator 0102, the tenant A administrator 0103, the tenant B administrator 0104, the tenant C administrator 0105, or the system developer 0201 uses. FIG. 5A is a diagram illustrating a hardware configuration of the client terminal 0240.

The client terminal 0240 is an external terminal which accesses the authoring system 0101. The client terminal 0240 includes a controller unit 500, an operation unit 510, and a display unit 512. The controller unit 500 is connected to each piece of hardware via a system bus 509, and exchanges information. The controller unit 500 loads a program, such as an OS or a web browser, recorded on a ROM 506 or an HDD 505 onto a RAM 503. The loaded program is sequentially processed by a CPU 502. The operation unit 510 is a reception unit which receives an operation performed by the user. The operation unit 510 is connected to an operation unit I/F 501, so that user operation information received by the operation unit 510 is communicated to the CPU 502 via the operation unit I/F 501. This operation information is processed by a program which operates on the CPU 502. With this processing, an operation performed by the user is processed, and an operation result is displayed on the display unit 512, which is connected to a display unit I/F 504, or is communicated to a network which is connected to a network I/F 507.

In the present exemplary embodiment, a web browser is executed on the client terminal 0240, and the web browser is used to access the authoring system 0101 illustrated in FIG. 1. The client terminal 0240 can be a general PC or can be portable terminal such as a smartphone.

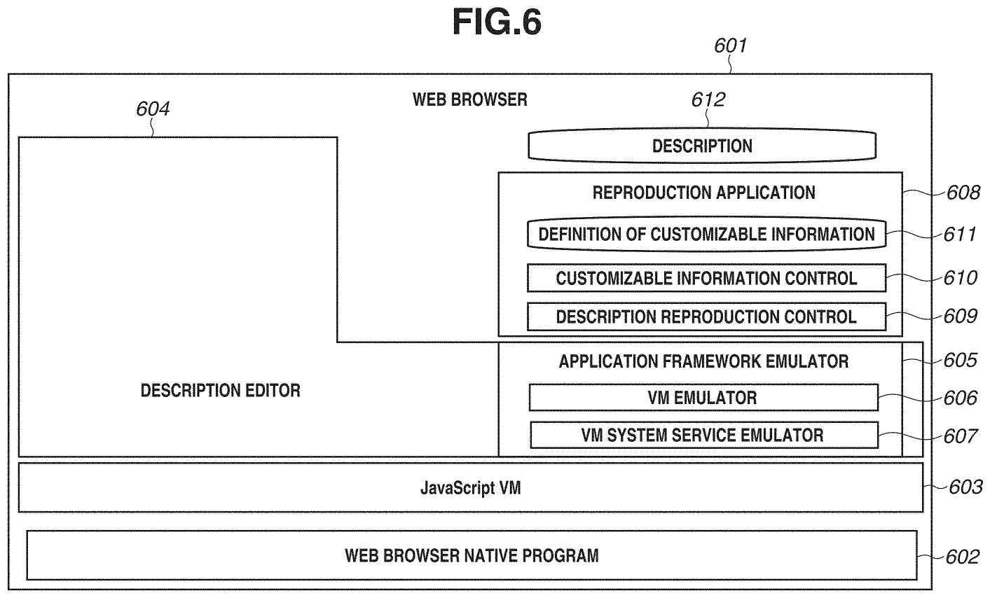

Next, a case where the client terminal 0240 executes a description editor on a web browser is described. FIG. 6 is a block diagram of a web browser which is displaying a description editor.

A web browser 601, which is software for connecting to a web server, is able to, for example, display a web page (webpage) and execute a program. The web browser 601 is able to execute a JavaScript VM 603 on a web browser native program 602, which is a native program for causing a web browser itself to operate. The JavaScript VM 603 is a program for causing JavaScript to operate on a web browser.

A description editor 604 is a program configured with JavaScript, and is an example of the description editor 0207 illustrated in FIG. 2A. The description editor 604 is executed on the JavaScript VM 603. The description editor 604 is a program which provides an editing environment for applications.

Moreover, the description editor 604 functions as an application framework emulator 605. The application framework emulator 605 performs emulation of an application framework for executing a program with a language different from JavaScript on the browser. The application framework emulator 605 is an example of the framework emulator 0208 illustrated in FIG. 2A. In the present exemplary embodiment, the application framework emulator 605 performs emulation with respect to an execution environment with the same language as the language of an application which is executed on the MFP 0203. Moreover, the application framework emulator 605 includes a VM system service emulator 607 and a VM emulator 606. The VM system service emulator 607 and the VM emulator 606 are programs which emulate, on JavaScript, operations of the VM 430 and the VM system service 420 illustrated in FIG. 4 and are configured with JavaScript.

A reproduction application 608 is an application (reproduction program) which operates based on a description customized by the user. The reproduction application 608 is configured in the same manner as in an application which is executed on an application framework of the MFP 0203. FIG. 6 illustrates a manner in which the reproduction application 608 is executed on the application framework emulator 605. The reproduction application 608 contains therein customizable information control 610, which performs processing concerning an inquiry about customizable information from the VM system service 420. Moreover, the reproduction application 608 contains therein a definition of customizable information 611 and description reproduction control 609, which reproduces a given description.

A description 612 is data which retains customization information edited by the user in a format which is able to be reproduced by the reproduction application 608. The description 612 is generated by the description editor 604 in response to the user issuing an instruction for an editing content with respect to an editing screen which the description editor 604 provides. The description editor 604 reproduces the description 612 generated in the reproduction application 608, which operates on the application framework emulator 605. This provides, to the use, an operation check screen for a customized application on a web browser.

While, in the present exemplary embodiment, JavaScript is used as a program language configuring the description editor 604, the description editor 604 can be configured with another type of code which is executable directly on a web browser, for example, WebAssembly.

Moreover, the reproduction application 608, which is executed by the description editor 604, does not need to be exactly identical to a reproduction application which is executed by the MFP 0203. For example, a configuration of loading an operation checking application obtained by clipping only a description reproduction control portion directly related to customization of a reproduction application can be employed.

Next, details of the description editor 604 are described. FIG. 5B is a diagram illustrating a software configuration of the description editor 604, which the client terminal 0240 executes.

The description editor 604 is a program which is obtained by the web browser 601 accessing a predetermined URL and performing downloading from a server and which is executed in the web browser 601, and is described in JavaScript. The description editor 604 includes an overall control unit 551, a screen configuration unit 552, a framework emulator control unit 556, a server communication unit 557, a description generation unit 555, a customized component information management unit 553, and a customized component information editing unit 554.

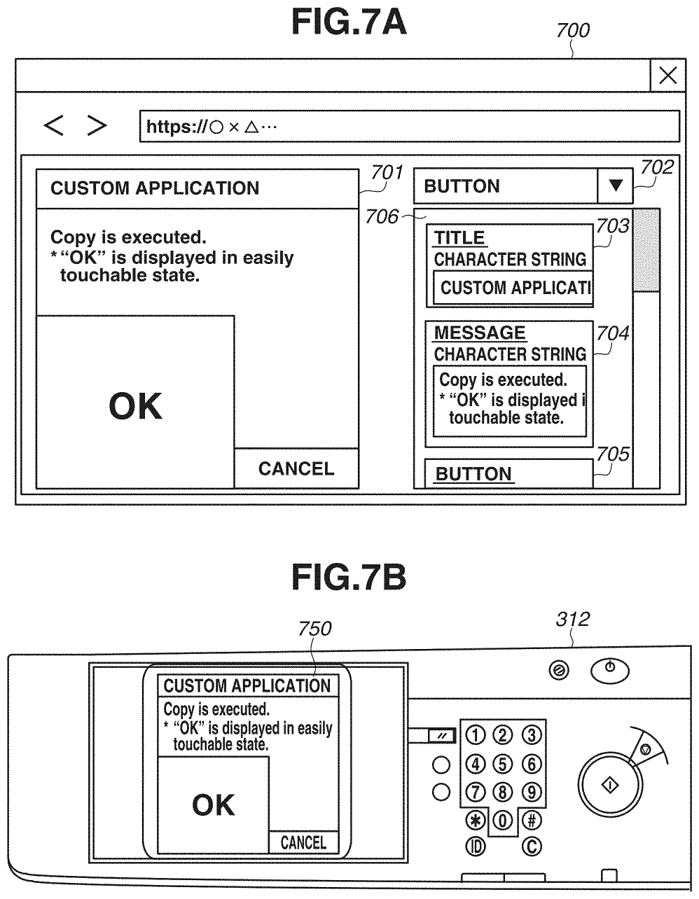

The overall control unit 551 is configured to control the overall description editor 604. The overall control unit 551 controls the description editor 604 in cooperation with each block. The screen configuration unit 552 is configured to control a screen configuration of the description editor 604. The screen configuration unit 552 updates Hypertext Markup Language (HTML) element and Cascading Style Sheets (CSS) (screen information) configuring a screen illustrated in FIG. 7A. Moreover, the screen configuration unit 552 receives an operation performed by the user and notifies the overall control unit 551 of the operation content (editing operation). The overall control unit 551 performs control as appropriate in response to such an operation notification. In a case where the operation information is operation information about an operation performed on a display region 701 for an application screen image, the overall control unit 551 notifies the framework emulator control unit 556 of the operation information. For example, in a case where the user has clicked the display region 701 for an application screen image, the framework emulator control unit 556 is notified of information indicating that a predetermined place in the application execution screen has been clicked. The framework emulator control unit 556 is configured to execute, on the Web, a reproduction application for reproducing a customized description. The reproduction application is configured to operate on an application framework in the MFP 0203 and is, therefore, not able to be executed directly on a web browser. Such a framework emulator performs emulation for executing an application directed to the MFP 0203 on the Web. The framework emulator control unit 556 receives a screen operation notification from the overall control unit 551, and notifies an application which is to be executed in the emulator of the received screen operation notification. The application having received the screen operation notification performs screen updating corresponding to the operation. The screen updating is implemented by a screen drawing API included in the application framework. This API is replaced with an image rendering API included in the web browser by the framework emulator, so that a display screen for the application is displayed in the display region 701 for an application screen image illustrated in FIG. 7A. The customized component information editing unit 554 is configured to acquire customizable component information from the reproduction application, perform conversion into a format usable in the description editor 604 based on the acquired information, and retain the component information. The screen configuration unit 552 configures a component list 702 and a display region 706 for customization setting information based on such component information. The customized component information management unit 553 is configured to manage setting information about customized components which are currently set. The screen configuration unit 552 configures a display region 706 for customization setting information based on such setting information. The description generation unit 555 is configured to generate a description based on the current setting information which is retained by the customized component information editing unit 554. The reproduction application is notified of the description via the framework emulator control unit 556. With this configuration, the reproduction application reproduces the description, so that the display region 701 for an application screen image illustrated in FIG. 7A is updated.

The server communication unit 557 performs control of communications with a server. The communications with a server include a communication for storing, in a server, component setting information stored in the customized component information editing unit 554 and a communication for downloading a reproduction application which is to be executed by the framework emulator control unit 556. With such communications, even if there is an increase or decrease or a change of operation in customizable information about a reproduction application, it is possible to provide an editing function tailored to the reproduction application without any change of the description editor 604.

### <Management of Description>

Details of generation and registration of a description described in step S904 to step S907 illustrated in FIG. 9 are described.

In step S902, the authoring system 0101 receives an access from the web browser of the client terminal 0240. Then, in step S903, the authoring system 0101 provides, to the client terminal 0240, the description editor 0207 and the framework emulator 0208, which are contained in the front-end resource 0204. In the case of creating a new description, the description editor 0207 transmits a description new creation notification to the description number management 0210, which is contained in the back-end program 0205 of the authoring system 0101. The description number management 0210, having received the description new creation notification, generates identifier information which does not overlap with identifier information about existing applications and identifier information about existing descriptions. Next, the back-end program 0205 identifies a tenant of the system user 0202 based on access information and determines a description storage destination. Next, the back-end program 0205 acquires version information about a reproduction application corresponding a description which is to be created. Next, the back-end program 0205 generates metadata from, for example, those pieces of identifier information and the version information about the reproduction application, and then transmits the metadata to a description editor of the client terminal 0240. In the case of editing an existing description, the description editor transmits a description readout request to the description pool A1 (0113). Then, the authoring system 0101 transmits the designated description and metadata to the description editor. In the case of creating a new description based on an existing description, the authoring system 0101 generates metadata in a manner similar to that in the processing performed in the case of creating a new description.

After new creation or reading of a description is performed, the description editor and the framework emulator perform customization and operation check of the description. The details of customization of a description are described below.

After customization of the description, the system user 0202 performs a storing operation for the customized description. The description editor, having received the storing operation, transmits the description to the authoring system 0101. The authoring system 0101 stores the description in the corresponding storage destination.

### <Editing of Description>

First, an execution screen of the description editor for creating a custom application is described. FIG. 7A is a diagram illustrating a screen of the description editor. When the user accesses the authoring system 0101 with the web browser and starts customization of an application, a screen 700 is displayed in the web browser. The screen 700 is configured with HTML, JavaScript, and CSS downloaded from a server, and a result obtained by the web browser interpreting those and rendering a screen is displayed. In the present exemplary embodiment, the manner of creating a custom application in which an execution button for copying has been made easily selectable in response to a customer's request is described as an example. The screen 700 has a plurality of items (objects) arranged therein, and provides an editing environment for applications to the user. Next, a principal configuration of the screen 700 is described.

The display region 701 is an image display region for displaying an execution image for an application in which the content customized by the user is reflected (an application being edited). While, in the present exemplary embodiment, an example in which this region is configured with the <canvas> element of HTML is described, this region can be configured with use of another renderable HTML element. Such a configuration enables the user to perform customization while viewing the region 701 to check whether a desired customization is being appropriately performed.

The component list 702 is a display object of the pull-down type for displaying a list of customizable (addible) display components. The user selects or adds a desired component from the component list 702, thus being able to perform customization for adding the component to an application. Examples of the editable components include a button able to be associated with a function, title information, and message information.

Since a result obtained by adding a component is immediately reflected in the display region 701, the user is able to readily check a customization condition.

The display region 706 is a customization setting information display region for displaying a component which is currently set and information which is set in the component. In FIG. 7A, a manner in which a title component 703, a message component 704, and a button component 705 are set is being displayed. The user edits information about a component which is being displayed in the display region 706, thus being able to perform customization of the component. For example, suppose that the user has edited a character string “custom application” which is being displayed in the title component 703 to read “test application”. Then, such editing is reflected in the display region 701, so that a portion described as “custom application” is updated to “test application”. Moreover, editing parameters of a component enables changing the size or layout of the component.

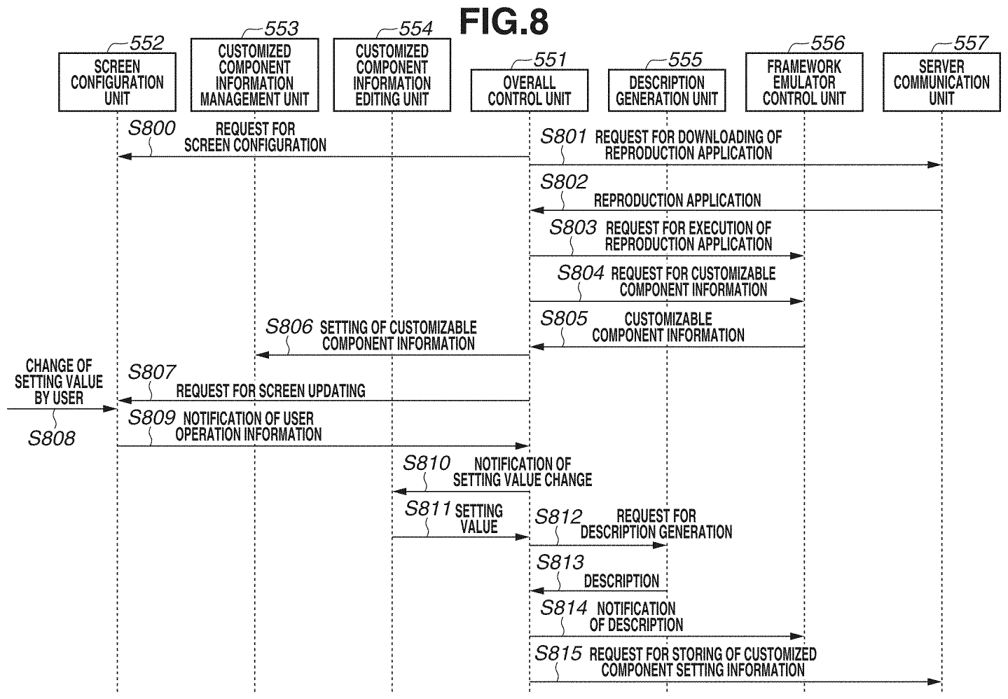

Next, an execution flow for the description editor 604 is described. FIG. 8 is a diagram illustrating a sequence between software modules of the description editor 604. Each processing operation is implemented by the controller unit 500. More specifically, each processing operation is implemented by the CPU 502 loading a program of the web browser 601 stored in the ROM 506 onto the RAM 503 and executing the program serving as the description editor 604 via the JavaScript VM 603.

In the execution flow for the description editor 604, first, in step S800, the overall control unit 551 requests a screen configuration from the screen configuration unit 552. The screen configuration unit 552 performs configuring an editing screen such as that illustrated in FIG. 7A. At this time, since customizable component information is undetermined, the component list 702 and the display region 706 for customization setting information are configured in an empty state. Next, in step S801, the overall control unit 551 requests downloading of a reproduction application from the server communication unit 557. In response to this request, the server communication unit 557 downloads the reproduction application from the server. In step S802, the server communication unit 557 communicates the downloaded reproduction application to the overall control unit 551. In step S803, the overall control unit 551 requests the framework emulator control unit 556 to execute the reproduction application. In response to this request, the framework emulator control unit 556 executes the reproduction application. Then, in step S804, the overall control unit 551 requests customizable component information from the framework emulator control unit 556. In step S805, in response to this request, the framework emulator control unit 556 requests customizable component information from the reproduction application and returns the acquired customizable component information to the overall control unit 551. In step S806, the overall control unit 551 communicates the acquired customizable component information to the customized component information management unit 553. The customized component information management unit 553 converts the communicated information into a data format adapted to be handled by the description editor 604. Next, in step S807, the overall control unit 551 requests the screen configuration unit 552 to perform screen updating. Here, since customizable component information has been determined, such information is reflected in the component list 702 and the display region 706 for customization setting information, so that the user is enabled to perform customization. Next, in step S808, the user adds a component via the component list 702. In step S809, in response to a notification of such a change, the screen configuration unit 552 communicates user operation information to the overall control unit 551. In step S810, the overall control unit 551 notifies the customized component information editing unit 554 that a setting value has been changed. In step S811, the customized component information editing unit 554 checks the setting value which has been set and then communicates the current setting value to the overall control unit 551. In step S812, the overall control unit 551 requests the description generation unit 555 to generate a description from the current setting value. In step S813, the description generation unit 555 generates a description corresponding to the current setting value and then communicates the generated description to the overall control unit 551. In step S814, the overall control unit 551 communicates the description to the framework emulator control unit 556. The framework emulator control unit 556 reproduces the description with the reproduction application, so that the display region 701 for an application screen image is updated. Finally, in step S815, the overall control unit 551 requests the server communication unit 557 to store the edited customized component setting information. In response to this request, the server communication unit 557 requests the server to store the customized component setting information. With this processing, customization information about an application which the user has set is stored in the server. In a case where the user performs customization of an application next time, this customization information is loaded, so that the user is able to perform customization starting with a state in which the edited information has been reflected.

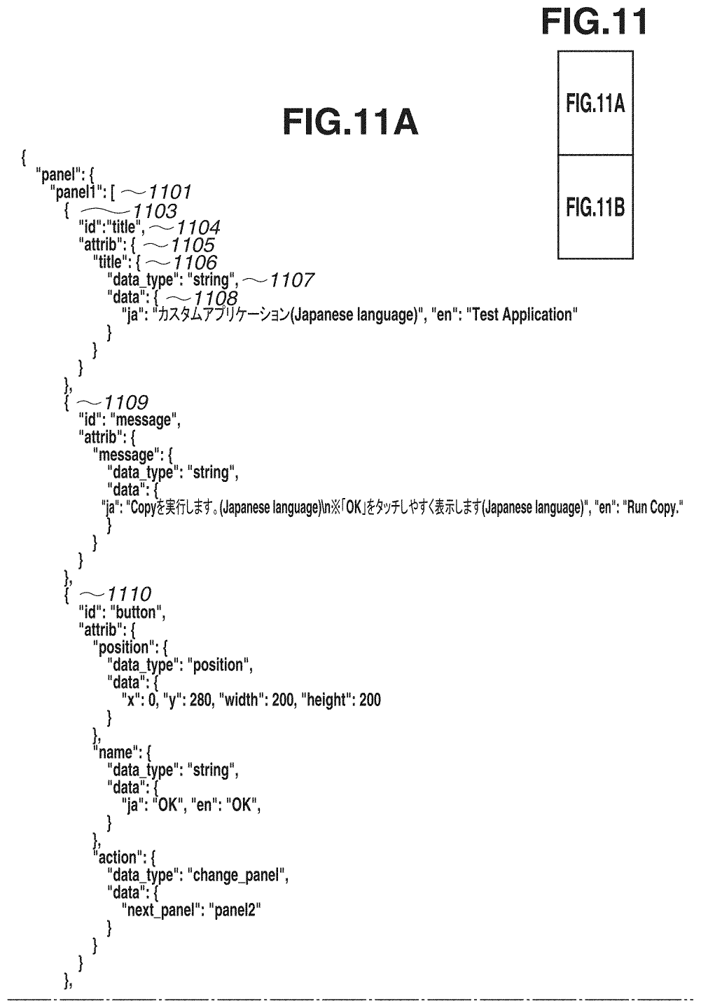

Next, a structure of the description is described. FIG. 11, which is composed of FIGS. 11A and 11B, is a diagram illustrating a description. FIG. 11 illustrates an example of a description corresponding to the customized application setting information illustrated in FIG. 7A. Thus, FIG. 11 illustrates a description corresponding to a program for displaying a copy execution check screen and executing a copy job at the time of an “OK” button being pressed. In the present exemplary embodiment, the content of a description is represented in a JavaScript Object Notation (JSON) format, which has a high affinity with a web browser. Another format can be used as the format of a description.

The description is configured with, roughly, two pieces of panel information 1101 and 1102. The panel information 1101 has, stored therein, information about components and customization information for every component. The information about components includes title component information 1103, message component information 1109, OK button component information 1110, and cancel button component information 1111. The customization information for every component includes component identification (ID) information 1104, component setting information 1105, component parameter information 1106, component parameter data type 1107, and component parameter data 1108. The component ID information 1104 is identification information indicating information about what component the customization information concerned is. In the case of this example, the component ID information 1104 indicates that the customization information concerned is customization information about the “title” component. The component setting information 1105 indicates setting information about that component. The component parameter information 1106 indicates customization information about a parameter of that component. The component parameter data type 1107 indicates a type of data about the component parameter. The component parameter data 1108 indicates a setting value of the component parameter. In a case where “data_type” is “string”, information about the localized character string is designated.

Accordingly, it can be seen that, in the title component information 1103, there is a “title” parameter in the “title” component and a localized character string “Custom Application” is set as a setting value of the parameter. Respective pieces of customization information are also similarly set to the message component information 1109, the OK button component information 1110, and the cancel button component information 1111.

The panel information 1102 has stored therein information for executing a job. In job execution component information 1112, “execute_job” is designated as a component for performing job execution. The job execution component information 1112 includes, as parameter setting values, a job identification (ID) 1114, which indicates what job to execute, and a job parameter 1115 for that job. Since this example is an application for executing copying, “copy” is designated in the job identification (ID) 1114. With the job parameter 1115, it is possible to register a parameter used for executing that job. Here, number-of-copies information 1116 and color mode 1117 are registered.

The above-mentioned description taken as an example is read in by, for example, the description reproduction control 609 of the reproduction application 608. Then, the reproduction application 608 configures a screen corresponding to the description and then performs screen transition and job execution control according to a user operation.

### <Installation of Custom Application>

Details of creation processing for a custom application mentioned in step S912 illustrated in FIG. 9 are described. The description registered with the authoring system 0101 is packaged in step S915, is provided as a custom application to the MFP 0203 in step S911, and is then installed in step S912. With the custom application installed, the reproduction application is executed in the MFP 0203, a description is read in by the script, and information designated in the description is reproduced. The MFP 0203 displays an execution screen as illustrated in FIG. 7B. FIG. 7B is a diagram illustrating an execution screen for a custom application in the MFP 0203. The execution screen is the same as that displayed in the display region 701 at the time of editing of the description, so that it can be seen that the MFP 0203 is operating normally. In the following description, processing concerning installation of a custom application is described in detail.

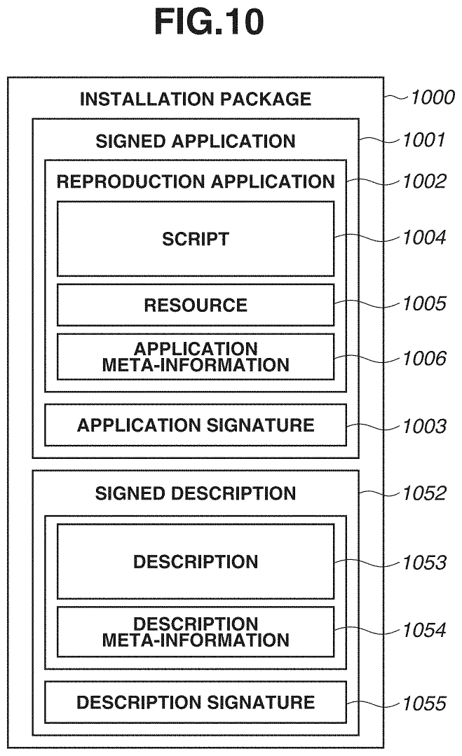

First, a structure of an installation package which the authoring system 0101 provides to the MFP 0203 is described. FIG. 10 is a diagram illustrating a data structure of an installation package.

The installation package 1000 is package data including a signed description 1052 and a signed application 1001.

The signed application 1001 includes a reproduction application 1002, which includes a script 1004, a resource 1005, and application meta-information 1006, and an application signature 1003. In the present exemplary embodiment, the same as a reproduction application retained by the description editor 604 is used as the signed application 1001.

On the other hand, the signed description 1052 is configured with a description 1053, description meta-information 1054, and a description signature 1055. The description 1053 is data which has been generated by the description editor 604 and is used to define a behavior of an application customized by the user. The details of the description 1053 are just as described with reference to FIG. 11. The description meta-information 1054 is information indicating an identifier (description identifier), version information, and application name of a customized application. The description signature 1055 is signature data for ensuring the integrity of the description 1053 and the description meta-information 1054. The description signature 1055 is generated with use of a signing key different from that of the application signature 1003. The signing key is previously retained in the authoring system 0101, and the description signature 1055, which is signature data, is generated by the description signature appending 0211.

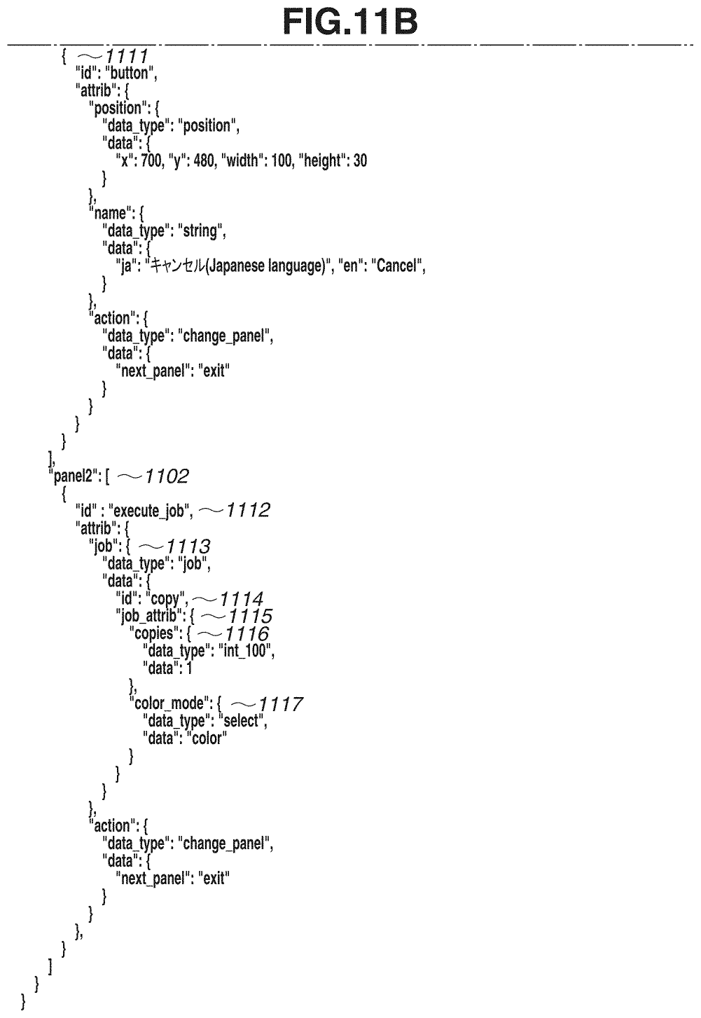

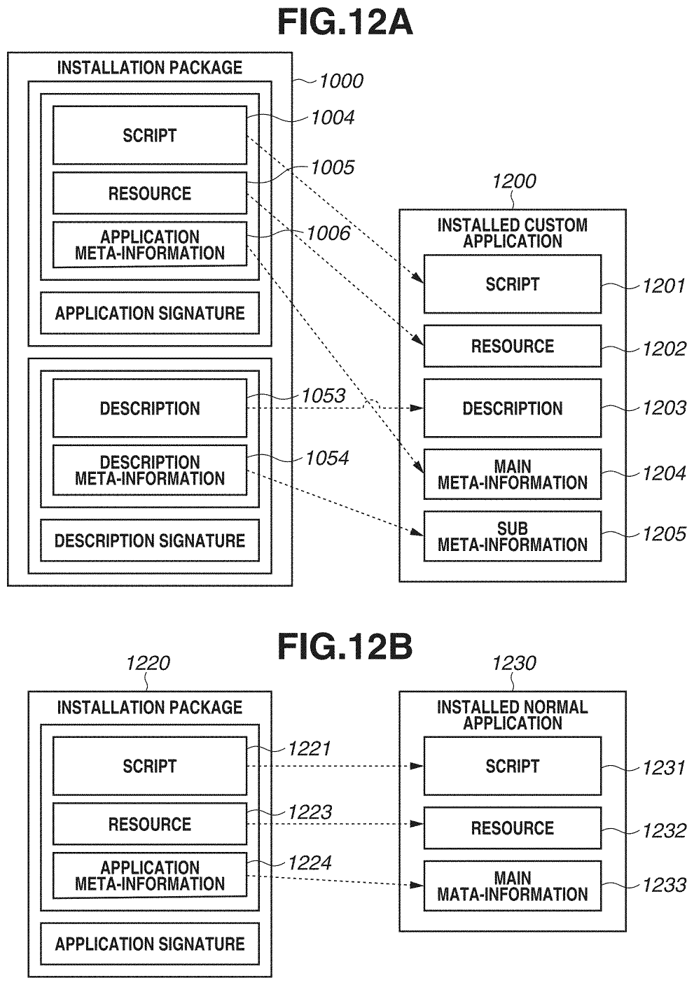

Processing for installing the above-mentioned installation package 1000 on the MFP 0203 is described in detail. FIG. 12A is a diagram illustrating an application structure which is retained in the storage of the MFP 0203 after a custom application is installed on the MFP 0203 and a corresponding installation package. The left-hand portion of FIG. 12A illustrates the installation package 1000, and the right-hand portion of FIG. 12A illustrates an installed custom application 1200. The configuration of the installation package 1000 is just as described above. On the other hand, the installed custom application 1200 is configured with a script 1201, a resource 1202, a description 1203, main meta-information 1204, and sub meta-information 1205. In application installation processing which is performed by the MFP 0203, each piece of data included in the installation package 1000 is read out, and is then reconstructed on the storage of the MFP 0203. Specifically, the script 1004 included in the installation package 1000 is arranged as the script 1201. The resource 1005 included in the installation package 1000 is arranged as the installed resource 1202. Moreover, the description 1053 included in the installation package 1000 is arranged as the installed description 1203. Additionally, the application meta-information 1006, which serves as information for uniquely identifying an installed application (an application identifier), is stored in a storage portion of the main meta-information 1204. Moreover, the description meta-information 1054 is stored in a storage portion of the sub meta-information 1205.

The main meta-information 1204 is information which is used to distinguish the installed custom application 1200 from another application installed on the MFP 0203. Moreover, the sub meta-information 1205 is information for uniquely identifying the content of a custom application (an identifier). In this way, the custom application 1200 is a combinational application obtained with a combination of pieces of information about the signed application 1001 and the signed description 1052. The combined pieces of information about the signed application 1001 and the signed description 1052 form combinational information.

For reference, installation of a normal application is also described. FIG. 12B is a diagram illustrating an application structure which is retained in the storage of the MFP 0203 after a normal application is installed on the MFP 0203 and a corresponding installation package.

The left-hand portion of FIG. 12B illustrates an installation package 1220, and the right-hand portion of FIG. 12B illustrates an installed normal application 1230. The installed normal application 1230 is configured with a script 1231, a resource 1232, and main meta-information 1233. In this way, in a case where a normal application has been installed, information corresponding to the description 1203 and information corresponding to the sub meta-information 1205 are not included in the installed normal application 1230. In this way, the normal application 1230 is a non-combinational application.

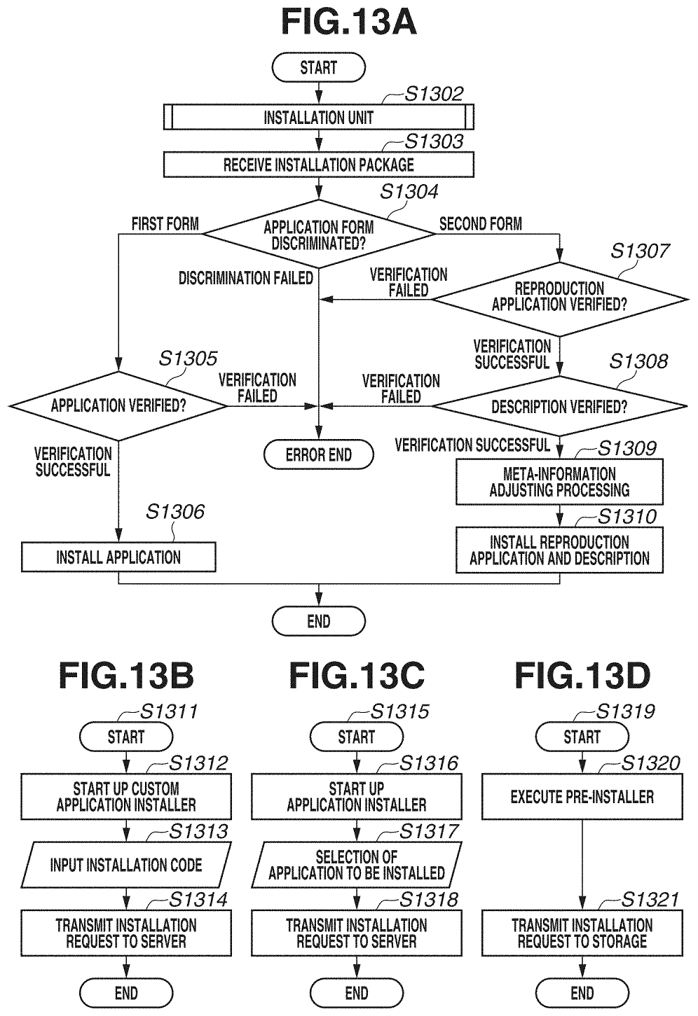

Next, control processing which is performed at the time of installing an application package is described. FIGS. 13A, 13B, 13C, and 13D are flowcharts illustrating an installation flow for an application package. Processing illustrated in FIGS. 13A to 13D represents processing which is performed by the application management unit 352. Thus, each processing operation is implemented by the controller unit 300. Specifically, each processing operation is implemented by the CPU 301 loading a program stored in the ROM 303 or the storage 304 onto the RAM 302 and executing the program.

First, in step S1302, the application management unit 352 transmits an installation request via an optional installation unit.

In the case of installation from the custom application delivery system 0213 (step S1311), in step S1312, the application management unit 352 starts up a custom application installer. In step S1313, the application management unit 352 receives inputting of an installation code by the system user 0202 or the user of the MFP 0203.

This corresponds to step S910. In step S1314, the application management unit 352 transmits, to the custom application delivery system 0213, an installation request using the input installation code. The method of inputting an installation code includes, for example, using a software keyboard included in the operation unit 312. However, another method can be used to input an installation code. For example, a configuration in which the user accesses web page data which the MFP 0203 provides with use of an information processing apparatus such as a PC and then transmits the content input via the keyboard to the MFP 0203 can be employed. Moreover, an installation code can be input by causing the scanner 370 to read a sheet of paper on which an installation code or information corresponding thereto is written.

In the case of installation of a normal application (step S1315), in step S1316, the application management unit 352 starts up an application installer. In step S1317, the application management unit 352 receives selection of an application to be installed, from the user of the MFP 0203. In step S1318, the application management unit 352 transmits, to an application server, an installation request for the selected application.

In the case of installation using a pre-installation application (step S1319), in step S1320, the application management unit 352 executes a pre-installer. In step S1321, the pre-installer started up transmits an installation request to an internal storage. In step S1303, the application management unit 352 receives an installation package for an application as a response to the installation request transmitted in step S1302. In step S1304, the application management unit 352 discriminates an application form of the application included in the received installation package.

If the application form is not able to be discriminated (DISCRIMINATION FAILED in step S1304), the application management unit 352 determines that the installation is failed and then ends the processing as an error end.

If the application form is a normal application (FIRST FORM in step S1304), then in step S1305, the application management unit 352 performs verification of the application. In the verification, the application management unit 352 uses the application signature 1003 to check whether incorrect information is not included in the script 1004, the resource 1005, or the application meta-information 1006.

If the verification is failed (VERIFICATION FAILED in step S1305), the application management unit 352 determines that the installation is failed and then ends the processing as an error end. If the verification is successful (VERIFICATION SUCCESSFUL in step S1305), then in step S1306, the application management unit 352 performs installation of the application.

If the application form is an application created in the authoring system 0101 (SECOND FORM in step S1304), then in step S1307, the application management unit 352 performs verification of the reproduction application. In the verification, the application management unit 352 checks whether the description 1053 and the description meta-information 1054 of the reproduction application are not incorrect ones, with use of the application signature 1003 of the reproduction application.

If the verification is failed (VERIFICATION FAILED in step S1307), the application management unit 352 determines that the installation is failed and then ends the processing as an error end. If the verification is successful (VERIFICATION SUCCESSFUL in step S1307), then in step S1308, the application management unit 352 uses the description signature 1055 to check whether incorrect information is not included in the description 1053 and the description meta-information 1054. If the verification is failed (VERIFICATION FAILED in step S1308), the application management unit 352 determines that the installation is failed and then ends the processing as an error end. If the verification is successful (VERIFICATION SUCCESSFUL in step S1308), then in step S1309, the application management unit 352 performs adjustment processing for meta-information. In the case of a custom application, there are two types of meta-information. Therefore, the application management unit 352 performs adjustment for storing meta-information 1006 about a reproduction application as main meta-information 1204 and storing meta-information 1054 about a description as sub meta-information 1205. In step S1310, the application management unit 352 performs installation of the reproduction application and the description.

### <Meta-Information>

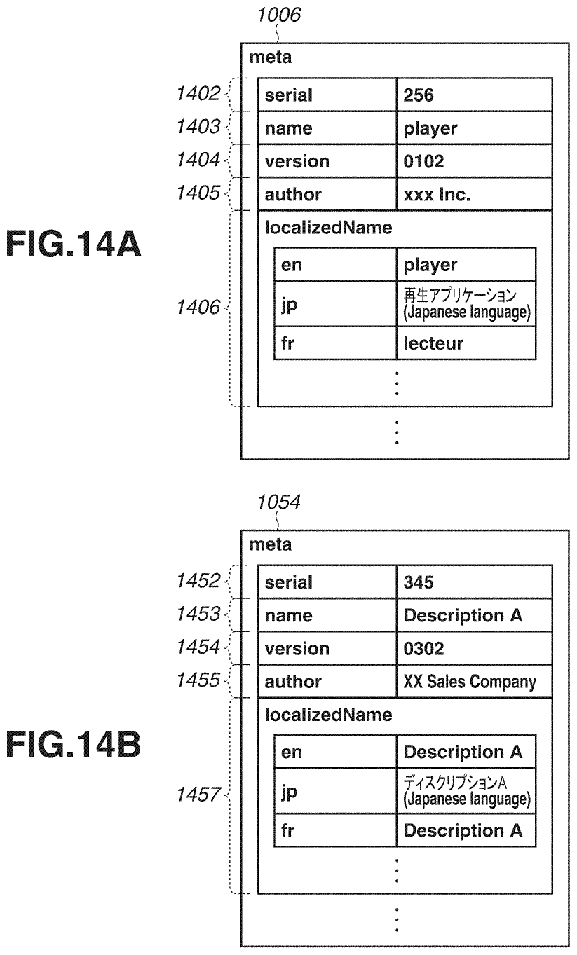

Details of meta-information are described. FIG. 14A is a diagram illustrating the details of meta-information about an application. FIG. 14B is a diagram illustrating the details of meta-information about a description. Each of meta-information 1006 about an application and meta-information 1054 about a description is information which is retained as a file of the JSON format.

As illustrated in FIG. 14A, the meta-information 1006 includes “serial” 1402 for identifying the application and “name” 1403 serving as a representative name. Moreover, the meta-information 1006 includes “version” 1404 serving as version information about the application and “author” 1405 indicating the author of the application. Moreover, the meta-information 1006 includes “localizedName” 1406 serving as the name of the application localized to each national language. The information “localizedName” 1406 is information which is used for displaying of an application management screen described below. In a case where the information “localizedName” 1406 is not stored, the information “name” 1403 serving as a representative name is used as information to be displayed.

As illustrated in FIG. 14B, the meta-information 1054 includes “serial” 1452 for identifying the description and “name” 1453 serving as a representative name. Moreover, the meta-information 1054 includes “version” 1454 serving as version information about the description and “author” 1455 indicating the author of the description. Moreover, the meta-information 1054 includes “localizedName” 1457 serving as the name of the description localized to each national language. The information “localizedName” 1457 is information which is used for displaying of an application management screen described below. In a case where the information “localizedName” 1457 is not stored, the information “name” 1453 serving as a representative name is used as information to be displayed.

### <Management of Application>

As described in the foregoing, various applications including, for example, a normal application and a custom application are able to be installed on the MFP 0203. In other words, various applications including, for example, a normal application and a custom application are able to be registered with the MFP 0203. Therefore, it is desirable that, even in a situation in which these applications coexist therein, the MFP 0203 be able to appropriately manage each application. In the present exemplary embodiment, a case where the servlet service 354 of the MFP 0203 provides page information for application management to an external apparatus is described. The page information is read in the web browser 601, which the client terminal 0240 executes, and is then output as screen information. Furthermore, the method of using the servlet service 354 is an example of a method of managing an application. As another method, a method of performing management with a dedicated program installed on the client terminal 0240 or a method of performing management with use of the operation unit 510 included in the MFP 0203 can be employed. Next, the flow of application management is described.

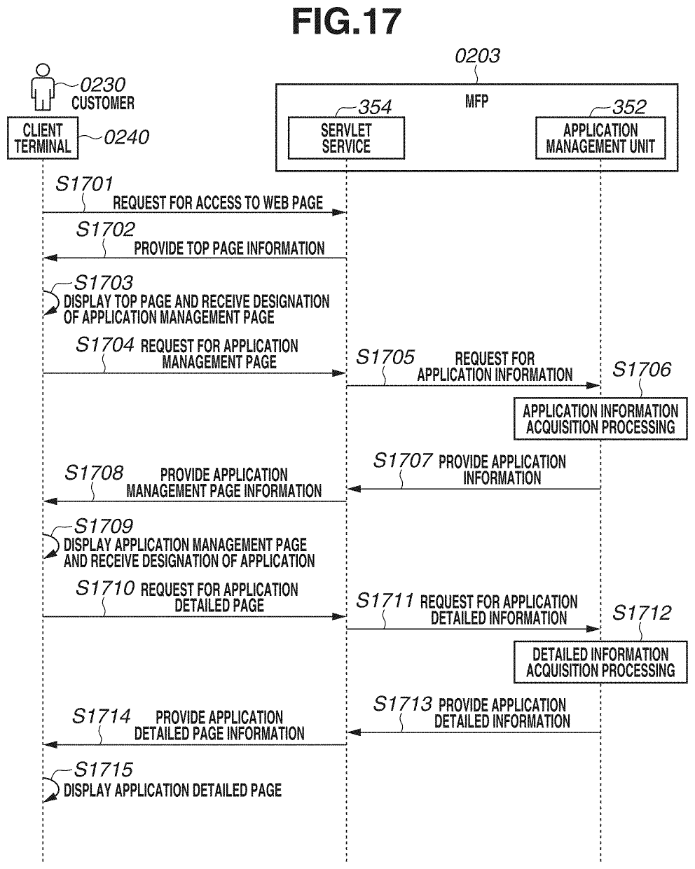

FIG. 17 is a diagram illustrating the flow of application management.

In step S1701, the client terminal 0240, having received an instruction from the user, transmits an access request for a web page to the servlet service 354.

In step S1702, the servlet service 354, having received the access request, provides top page information to the client terminal 0240. Furthermore, in providing page information, the servlet service 354 can perform an authentication procedure such as requesting inputting of a user ID and a password.

In step S1703, the client terminal 0240, having received the top page information, outputs (displays) screen information (not illustrated) about the top page.

In step S1704, the client terminal 0240, having received, from the user, an instruction for transition to an application management page, requests the application management page from the servlet service 354.

In step S1705, the servlet service 354 requests application information from the application management unit 352.

In step S1706, the application management unit 352 performs application information acquisition processing. Details of the application information acquisition processing are described below.

In step S1707, the application management unit 352 transmits application information to the servlet service 354.

In step S1708, the servlet service 354 transmits application management page information to the client terminal 0240.

In step S1709, the client terminal 0240 outputs screen information based on the application management page information. Then, the client terminal 0240 receives a user instruction for designating an application.

In step S1710, the client terminal 0240 requests an application detailed page from the servlet service 354.

In step S1711, the servlet service 354 requests application detailed information from the application management unit 352.

In step S1712, the application management unit 352 performs detailed information acquisition processing. In the present exemplary embodiment, the application management unit 352 acquires main meta-information about each installed application. Moreover, in a case where the application is a custom application, the application management unit 352 also acquires sub meta-information.

In step S1713, the application management unit 352 transmits application detailed information to the servlet service 354.

In step S1714, the servlet service 354 provides application detailed page information to the client terminal 0240.

In step S1715, the client terminal 0240 outputs screen information based on the application detailed page information.

### <Screen>

Screen information about an application management page which is displayed in step S1709 is described.

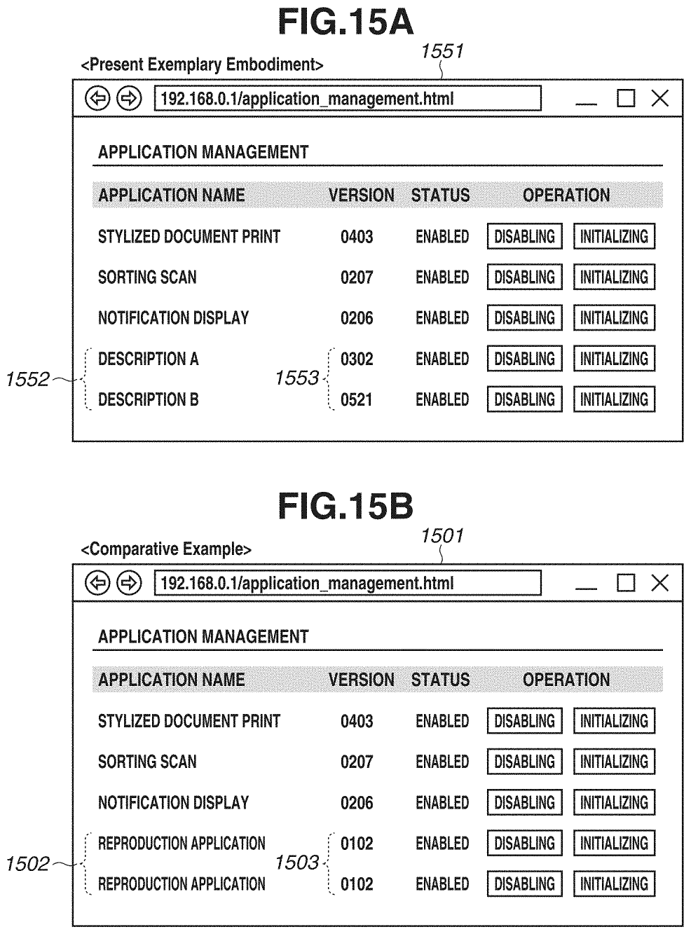

FIG. 15A is a diagram illustrating an application management screen. FIG. 15B is a diagram illustrating an application management screen in a comparative example.

As illustrated in FIG. 15A, in an application management screen 1551, list information in which respective pieces of identification information (name information) about applications installed on the MFP 0203 are browsable is displayed. Identification information about an application includes, for example, an application name, version, status, and operation. The user can select, in this screen, an enabling/disabling button and an initializing button which are arranged in association with each application. If the enabling/disabling button is selected, switching is performed between an enabled state and a disabled state of the corresponding application. If the initializing button is selected, the settings of the corresponding application are initialized.

In the application management screen 1551, information which is displayed as the application name is, ordinarily, information acquired from application meta-information about each application.

Specifically, names of normal applications, such as “stylized document print”, “sorting scan”, and “notification display”, are displayed.

However, in the present exemplary embodiment, as shown in the description names 1552, information acquired from description meta-information is used for a custom application. While, here, for ease of explanation, the description names 1552 are represented as, for example, “description A” and “description B”, actually, specific names stored in descriptions, such as “custom copy application” and “custom scan application”, are displayed.

Similarly, as shown in the versions 1553, information acquired from description meta-information is used for a custom application. This is designed to solve an issue caused by the configuration of a custom application. In a case where, as illustrated in FIG. 15B, description meta-information is not used for a custom application, meta-information about reproduction applications is used as application names 1502 and versions 1503. As mentioned above, a reproduction application is a general-purpose application for a custom application for performing processing that is based on a description. Therefore, even when two different custom applications have been installed, respective pieces of application information would become the application names 1502 and the versions 1503, which are information about reproduction applications. This does not enable discriminating custom applications, so that it is impossible to appropriately apply management, such as disabling or initializing, to custom applications. Therefore, in the present exemplary embodiment, instead of application meta-information, description meta-information is used, so that it is possible to provide an appropriate application management screen.

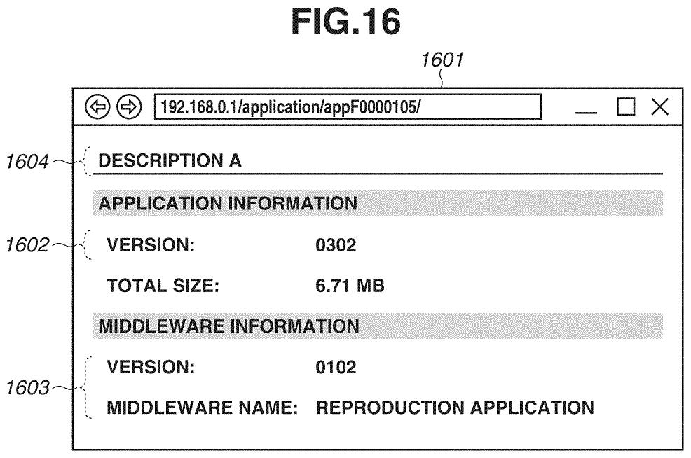

Moreover, in the application management screen 1551, each application name is configured as a link. Therefore, selecting an application name enables transitioning to a detailed screen for the corresponding application. FIG. 16 is a diagram illustrating an application detailed screen. When, in the application management screen 1551, “description A” is selected, the application management screen 1551 transitions to an application detailed screen 1601. In the application detailed screen 1601, detailed information about a custom application including the description A is displayed. Detailed information about an application may be checked, for example, when a failure has occurred in a custom application, so as to identify the cause of the failure. For example, a user who makes an inquiry about the failure communicates the name and version information about a description and the name and version of an application to a customer service.

The detailed information in the application detailed screen 1601 includes the name 1604 and version information 1602 about the description A and middleware information (the name and version information about the reproduction application) 1603.

### <Application Information Acquisition Processing>

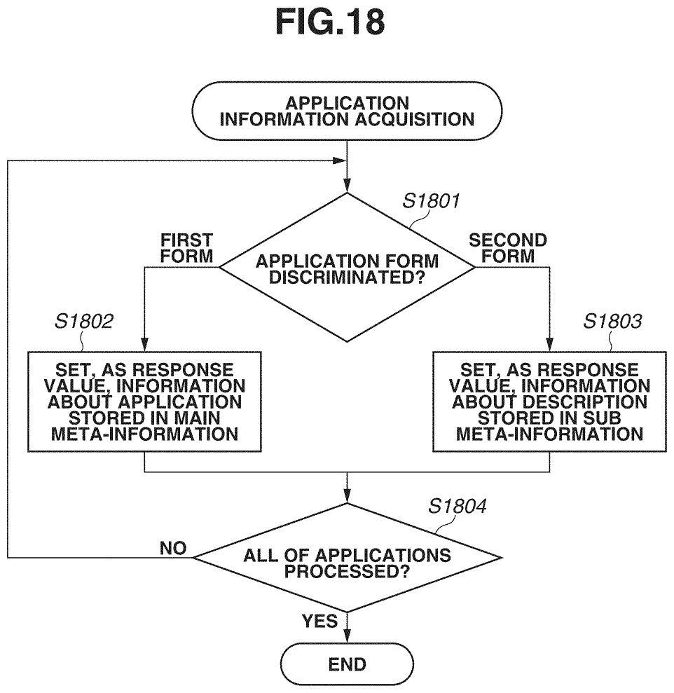

Application information acquisition processing is described as processing for solving the above-mentioned issue caused by the configuration of a custom application. FIG. 18 is a flowchart illustrating acquisition processing for application information. Each processing operation is performed by the application management unit 352. Specifically, the acquisition processing is implemented by the CPU 301 loading a program stored in the ROM 303 or the storage 304 onto the RAM 302 and executing the program.

In step S1801, the application management unit 352 discriminates the form of an application from which meta-information is next acquired. If the application form is a first form, i.e., a normal application (FIRST FORM in step S1801), the application management unit 352 advances the processing to step S1802. If the application form is a second form, i.e., a custom application (SECOND FORM in step S1801), the application management unit 352 advances the processing to step S1803.

In step S1802, the application management unit 352 acquires main meta-information 1233 and sets the acquired main meta-information 1233 as data used for response. As mentioned above, meta-information about an application is stored in the main meta-information 1233. Then, the application management unit 352 advances the processing to step S1804.

Then, in step S1803, the application management unit 352 acquires sub meta-information 1205 and sets the acquired sub meta-information 1205 as data used for response. As mentioned above, meta-information about a description is stored in the sub meta-information 1205. Then, the application management unit 352 advances the processing to step S1804.

In step S1804, the application management unit 352 checks whether meta-information has been acquired with respect to all of the installed applications. If there is an application from which meta-information has not yet been acquired (NO in step S1804), the application management unit 352 returns the processing to step S1801. If meta-information has been acquired with respect to all of the applications (YES in step S1804), the application management unit 352 ends the application information acquisition processing. After that, the data set as response data is transmitted to the servlet service 354 in step S1707. Furthermore, a configuration in which, each time acquiring meta-information, the application management unit 352 transmits the acquired meta-information to the servlet service 354 can be employed.

As described above, the authoring system 0101 provides an environment capable of readily editing and delivering an application. Since this enables a person such as a service engineer or a technical salesperson to create a custom application, it becomes possible to swiftly provide an application which a customer desires.

Moreover, the MFP 0203 manages information (particularly, an identifier) about a description separately from information (particularly, an identifier) about a reproduction application. Then, the MFP 0203 displays a description name and a description version instead of an application name and an application version. Such a configuration enables appropriately managing a custom application with an operability similar to that for a normal application.

In the above-described exemplary embodiment, a configuration in which meta-information about an application is stored in the main meta-information 1233 and meta-information about a description is stored in the sub meta-information 1205 has been described. However, as long as capable of appropriately managing a custom application with use of meta-information about a description, the method of managing meta-information can be another method.

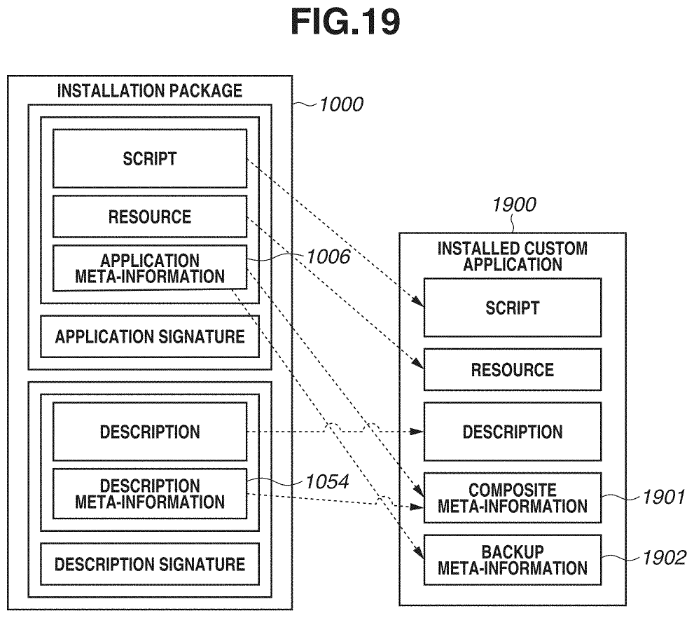

For example, as illustrated in FIG. 19, after meta-information about an application is stored, processing can be performed in such a way as to overwrite this meta-information with meta-information about a description. FIG. 19 is a diagram used to explain another example of installation of a custom application. In FIG. 19, application meta-information 1006 is stored, and, after that, processing for overwriting a part or the whole of this meta-information with description meta-information 1054 is performed. Such processing brings about a state in which composite meta-information has been stored in the MFP 0203. The reason of once storing the application meta-information 1006 is to make the format of meta-information consistent with that of a normal application. In this example, the composite meta-information 1901 is treated equally with the main meta-information 1233 about a normal application. Thus, in step S1706, without the determination processing illustrated in FIG. 18 being performed, the composite meta-information 1901 is acquired as application information. Furthermore, in the composite meta-information 1901, the application meta-information 1006 would be deleted due to overwrite processing. Therefore, to be prepared for a situation in which the application meta-information 1006 has to be used, such a configuration that the application meta-information 1006 is stored in backup meta-information 1902 can be employed.

In the above-described exemplary embodiment, a custom application which is generated by a large-scale authoring system has been described as an example of a target for management. However, an environment which provides a custom application does not need to be a large-scale authoring system. As long as capable of providing a custom application which is configured with a reproduction application and a description, for example, a program which is installed on a PC can be used to provide a custom application.

In the above-described exemplary embodiment, an example in which, in a detailed screen, the name and version of a description are displayed in the name and version of a reproduction application has been described. However, another piece of information can be used as meta-information to be displayed. For example, information such as the revision number or build number of an application or description can be used.

Moreover, contact information about a developer of an application or description can be displayed.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

The disclosure can be applied to a system configured with a plurality of apparatuses or can be applied to an apparatus configured with a single device.

The disclosure is not limited to the above-described exemplary embodiment, but can be altered or modified in various manners based on the gist of the disclosure, so that such alterations or modifications should not be construed to be excluded from the scope of the disclosure.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-125160 filed Jul. 30, 2021, which is hereby incorporated by reference herein in its entirety.

What is claimed is:

1. An information processing apparatus comprising:
one or more controllers configured to function as:
a first unit configured to register, as a combinational application, combinational information about a description file, in which an operation procedure is defined, and a reproduction application, which reproduces the description file;
a second unit configured to register a non-combinational application which does not use the description file; and
a third unit configured to output list information including identification information about the combinational application and identification information about the non-combinational application,
wherein, in the list information, identification information about the description file is used as the identification information about the combinational application.

2. The information processing apparatus according to claim 1, wherein the list information is screen information in which name information concerning a plurality of applications installed on the information processing apparatus is browsable.

3. The information processing apparatus according to claim 1, wherein the list information is screen information in which version information concerning a plurality of applications installed on the information processing apparatus is browsable.

4. The information processing apparatus according to claim 1, wherein the list information is displayed in an external apparatus connected to the information processing apparatus via a network.

5. The information processing apparatus according to claim 4, wherein the list information is provided as web page data to the external apparatus.

6. The information processing apparatus according to claim 1, wherein the list information is displayed on a display circuit included in the information processing apparatus.

7. The information processing apparatus according to claim 1,
wherein a first combinational application and a second combinational application are registrable as the combinational application,
wherein a reproduction application included in the first combinational application and a reproduction application included in the second combinational application include an identical application identifier, and
wherein a description file included in the first combinational application and a description file included in the second combinational application include respective different description identifiers.

8. The information processing apparatus according to claim 1, wherein the combinational application is a program which is installed on the information processing apparatus based on package data including the reproduction application and the description file.

9. The information processing apparatus according to claim 1, wherein the one or more controllers are configured to further function as a fourth unit configured to, in installation processing for the combinational application, store an application identifier of the reproduction application in a first storage circuit and store a description identifier of the description file in a second storage circuit.

10. The information processing apparatus according to claim 1, wherein the one or more controllers are configured to further function as a fifth unit configured to, in installation processing for the combinational application, store an application identifier of the reproduction application in a storage circuit and, after that, store a description identifier of the description file in the storage circuit in an overwriting manner.

11. The information processing apparatus according to claim 1, wherein the one or more controllers are configured to further function as a sixth unit configured to, in installation processing for the combinational application, perform registration processing for the combinational application using a description identifier of the description file instead of an application identifier of the reproduction application.

12. The information processing apparatus according to claim 1, wherein the one or more controllers are configured to further function as a seventh unit configured to, in installation processing for the combinational application, register a description identifier of the description file in conformity with a format of an application identifier of the reproduction application.

13. The information processing apparatus according to claim 1, wherein the one or more controllers are configured to further function as a eighth unit configured to, in installation processing for the combinational application, after storing an application identifier of the reproduction application, overwrite the application identifier with a description identifier of the description file.

14. The information processing apparatus according to claim 1, wherein the description file is data described in a JavaScript Object Notation (JSON) format.

15. The information processing apparatus according to claim 1, wherein the information processing apparatus includes an image forming circuit configured to form an image on a sheet.

16. The information processing apparatus according to claim 1, wherein the information processing apparatus includes an image reading circuit configured to read an image from an original.

17. A non-transitory storage medium storing a method for controlling an information processing apparatus, the method comprising:
registering, as a combinational application, combinational information about a description file, in which an operation procedure is defined, and a reproduction application, which reproduces the description file;
registering a non-combinational application which does not use the description file; and
outputting list information including identification information about the combinational application and identification information about the non-combinational application,
wherein, in the list information, identification information about the description file is used as the identification information about the combinational application.

18. An information processing system comprising:
one or more controllers configured to function as:
a first unit configured to register, as a combinational application, combinational information about a description file, in which an operation procedure is defined, and a reproduction application, which reproduces the description file;
a second unit configured to register a non-combinational application which does not use the description file; and
a third unit configured to output list information including identification information about the combinational application and identification information about the non-combinational application,
wherein, in the list information, identification information about the description file is used as the identification information about the combinational application.
